(19) United States
(12) Patent Application Publication
(10) Pub. No.: US 2026/0277674 A1
(43) Pub. Date: Sep. 17, 2026

(54) BLOCKCHAIN-BASED CONSENSUS FRAMEWORK FOR MANAGEMENT OF BELIEF SPACES

(71) Applicant: Infosys Limited, Bangalore (IN)

(72) Inventors: Rajeshwari Ganesan, Bellevue, WA (US); Debrup Dey, Bengaluru (IN); Shubham Aggarwal, London (GB); Akshatha Miyal Kamath, Bengaluru (IN)

(73) Assignee: Infosys Limited, Bangalore (IN)

(21) Appl. No.: 19/370,047

(22) Filed: Oct. 27, 2025

Related U.S. Application Data
(60) Provisional application No. 63/771,444, filed on Mar. 13, 2025.

(51) Int. Cl. G06F 9/48; G06F 30/20; H04L 9/00

(52) U.S. Cl. CPC G06F 9/4887; G06F 30/20; H04L 9/50; H04L 2209/463

(57) ABSTRACT

A system for facilitating implementation of a blockchain-based consensus framework for management of digital artifacts and corresponding belief spaces is provided. The system includes a storage element and processing circuitry coupled thereto. The storage element stores a set of digital artifacts. The set of digital artifacts is associated with a set of belief spaces. The set of belief spaces is stored in a decentralized storage network. The processing circuitry receives a first event request associated with at least a first digital artifact and determines a set of acceptance criteria based on the intent of the first event request. The processing circuitry executes an evaluation process in accordance with the acceptance criteria. Based on the execution of the evaluation process, the processing circuitry generates an evaluation response indicative of approval or rejection of the first event request.

### CROSS-REFERENCE TO RELATED APPLICATIONS

The present application is related to and claims priority to U.S. Patent Application Ser. No. 63/771,444, filed on March 13, 2025, and entitled “LEGACY CODE MODERNIZATION”, the contents of which are incorporated herein by reference.

### FIELD OF THE DISCLOSURE

Various embodiments of the present disclosure relate generally to consensus frameworks for management of belief spaces. More specifically, various embodiments of the present disclosure relate to Byzantine fault-tolerant consensus mechanisms for managing belief states.

### BACKGROUND

In software product management systems, stakeholders (for example, developers, end-users, security analysts, auditors, or the like) are frequently required to make decisions regarding digital artifacts such as code modules, database schemas, system configurations, development strategies, or the like. These human-driven decisions present significant challenges in context of evolution and maintenance of a software product. The stakeholders may propose changes that may be malicious in nature, technically incorrect, or based on incomplete information about current state and interdependencies associated with digital artifacts of the software product. Such flawed decision-making can result in corruption, degradation, or complete failure of digital artifacts within the software ecosystem of the software product, potentially compromising the software product.

Notably, the complexity of the software product, with intricate dependencies among the digital artifacts associated therewith and often undocumented relationships between components, exacerbates these risks. When stakeholders make decisions about modifying or updating the software product without full visibility and a comprehensive understanding of the digital artifacts associated with the software product, the consequences can be far-reaching. For instance, a decision to decommission what appears to be an unused software module may inadvertently break significant business processes that depend on that module through obscure pathways.

Conventionally, the identification of these problematic decisions typically occurs well after their implementation, often only becoming apparent during system testing, production deployment, or even post-deployment operations. By this time, substantial financial losses may have been incurred due to system downtime, failed development efforts, or the need to completely restart software product initiatives. Additionally, significant resource degradation may occur, including loss of important data, corruption of digital artifacts, or destruction of valuable institutional knowledge embedded within a codebase of the software product.

The traditional approach of relying solely on human oversight and standard operating procedures has proven insufficient to address these challenges, particularly in high-stakes software product management scenarios where the cost of failure can be substantial and the window for corrective action is limited.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for implementation of a blockchain-based consensus framework for management of belief spaces are provided substantially as shown in, and described in connection with, at least one of the figures.

In an embodiment of the present disclosure, a blockchain-based consensus framework for management of belief spaces is disclosed. The blockchain-based consensus framework for management of belief spaces is implemented by way of a system disclosed herein. The system may include a storage element and processing circuitry that is communicably coupled to the storage element. The storage element is configured to store a set of digital artifacts. The set of digital artifacts is associated with a set of belief spaces. The set of belief spaces is stored in a decentralized storage network associated with the system. The processing circuitry is configured to receive a first event request associated with at least a first digital artifact of the set of digital artifacts. The first event request is indicative of a proposed change to at least the first digital artifact. The proposed change, when committed, is to be reflected by a first belief space of the set of belief spaces, associated with at least the first digital artifact. The processing circuitry is further configured to determine, based on an intent of the first event request, a set of acceptance criteria associated with the first event request. The processing circuitry is further configured to execute an evaluation process associated with the first event request in accordance with the set of acceptance criteria. The processing circuitry is further configured to generate an evaluation response based on the execution of the evaluation process. The evaluation response is indicative of one of: an approval of the first event request or a rejection of the first event request.

In some embodiments, based on the evaluation response being indicative of the approval of the first event request, the processing circuitry is further configured to execute a first set of operations associated with the first event request. The processing circuitry is further configured to commit, based on the execution of the first set of operations, the proposed change to at least the first digital artifact.

In some embodiments, the processing circuitry is further configured to access the first belief space in the decentralized storage network. The processing circuitry is further configured to update the first belief space based on the commitment of the proposed change to at least the first digital artifact.

In some embodiments, the first belief space corresponds to a set of belief types associated with a set of belief states. A first belief type of the set of belief types is indicative of a first attribute associated with at least the first digital artifact. A first belief state, of the set of belief states, is associated with the first belief type. The first belief state is indicative of a current state of the first attribute. To update the first belief space, the processing circuitry is further configured to identify, based on a first context of the first set of operations, a subset of belief types of the set of belief types. The subset of belief types corresponds to one or more attributes associated with at least the first digital artifact, with a change in corresponding current states based on the commitment of the proposed change to at least the first digital artifact. The processing circuitry is further configured to update a subset of belief states of the set of belief states, associated with the subset of belief types based on a set of outputs of the first set of operations.

In some embodiments, the storage element is further configured to store a set of logic constraints. The processing circuitry is further configured to identify, based on the intent of the first event request, a first subset of logic constraints of the set of logic constraints associated with the first event request. The set of acceptance criteria associated with the first event request is determined further based on the first subset of logic constraints.

In some embodiments, the storage element is further configured to store a set of logic constraints. The processing circuitry is further configured to identify, based on the intent of the first event request, a second subset of logic constraints of the set of logic constraints associated with the first event request. The evaluation process associated with the first event request is executed further based on the second subset of logic constraints.

In some embodiments, the storage element is further configured to store at least one of: a set of validator agents, a simulator agent, or an orchestrator agent.

In some embodiments, the set of acceptance criteria is indicative of at least one of: a count of validator agents required for an evaluation of the first event request, a count of validator agents required for the approval of the first event request, or one or more evaluation constraints associated with at least one of: the evaluation of the first event request or an execution of the first event request.

In some embodiments, for the execution of the evaluation process, the processing circuitry is further configured to select, based on utilization of the orchestrator agent, a subset of validator agents from the set of validator agents based on the count of validator agents required for the evaluation of the first event request. The processing circuitry is further configured to communicate, via the orchestrator agent, at least one of: the first event request or the one or more evaluation constraints associated with at least one of: the evaluation of the first event request or the execution of the first event request to the simulator agent. The simulator agent is configured to create a simulation environment associated with at least the first digital artifact. The simulator agent is further configured to execute a first set of operations associated with the first event request for at least the first digital artifact in the simulation environment. The simulator agent is further configured to communicate a set of outputs associated with the first set of operations to the orchestrator agent.

In some embodiments, the processing circuitry is further configured to communicate, based on the utilization of the orchestrator agent, the set of outputs to the subset of validator agents. Each validator agent of the subset of validator agents is configured to evaluate the first event request based on at least one of: the set of outputs or the one or more evaluation constraints. Each validator agent of the subset of validator agents is further configured to generate an intermediate evaluation response based on the evaluation of the first event request. Each validator agent is further configured to communicate the intermediate evaluation response to the orchestrator agent.

In some embodiments, for the evaluation of the first event request, the subset of validator agents, collectively or individually, is configured to monitor the execution of the first set of operations in the simulation environment. The subset of validator agents, collectively or individually, is further configured to determine a set of observations associated with the execution of the first set of operations. The first event request is evaluated further based on the set of observations. The subset of validator agents, collectively or individually, is further configured to identify a set of collateral operational conditions pertaining to a subset of digital artifacts of the set of digital artifacts. Each digital artifact of the subset of digital artifacts is associated with at least the first digital artifact. The execution of the first set of operations causes the set of collateral operational conditions. The intermediate evaluation response is generated further based on the set of collateral operational conditions.

In some embodiments, the association of each digital artifact of the subset of digital artifacts with at least the first digital artifact is one of: a syntactic association or a semantic association.

In some embodiments, the processing circuitry is further configured to generate the evaluation response based on the utilization of the orchestrator agent. The orchestrator agent is configured to receive the intermediate evaluation response from each validator agent of the subset of validator agents. The intermediate evaluation response is indicative of one of: the approval of the first event request or the rejection of the first event request. The orchestrator agent is further configured to determine that one of: a count of intermediate evaluation responses indicative of the approval of the first event request exceeds the count of validator agents required for the approval of the first event request, or the count of intermediate evaluation responses is less than the count of validator agents required for the approval of the first event request. The orchestrator agent is further configured to generate the evaluation response that is indicative of the approval of the first event request based on the count of intermediate evaluation responses exceeding the count of validator agents required for the approval of the first event request. The orchestrator agent is further configured to generate the evaluation response that is indicative of the rejection of the first event request based on the count of intermediate evaluation responses being less than the count of validator agents required for the approval of the first event request.

In some embodiments, the orchestrator agent is further configured to generate a set of feedback based on a second context associated with the evaluation response. The set of feedback is indicative of a set of reasoning pertaining to the evaluation response being indicative of one of: the approval of the first event request or the rejection of the first event request.

In some embodiments, based on the evaluation response being indicative of the approval of the first event request, the processing circuitry is further configured to schedule an execution of a first set of operations associated with the first event request based on an expiration of a predefined time interval. The processing circuitry is further configured to receive an override request for the first event request prior to the expiration of the predefined time interval. The processing circuitry is further configured to evaluate the override request based on a third context thereof. The processing circuitry is further configured to update the scheduled execution of the first set of operations based on the evaluation of the override request.

In some embodiments, the processing circuitry is further configured to receive a second event request associated with at least one of: at least the first digital artifact or a second digital artifact of the set of digital artifacts. The processing circuitry is further configured to determine that a first set of operations associated with the first event request conflicts with a second set of operations associated with the second event request. The processing circuitry is further configured to generate, for each of the first event request and the second event request, a corresponding priority score. A first priority score and a second priority score associated with the first event request and the second event request is generated based on a first source of the first event request and a second source of the second event request, respectively. The processing circuitry is further configured to schedule execution of at least one of the first set of operations or the second set of operations based on the first and second priority scores.

In another embodiment of the present disclosure, a computer-implemented method is disclosed. The method includes receiving, by the processing circuitry, the first event request associated with at least the first digital artifact of the set of digital artifacts stored in the storage element. The set of digital artifacts is associated with the set of belief spaces. The set of belief spaces is stored in the decentralized storage network. The first event request is indicative of the proposed change to at least the first digital artifact. The proposed change, when committed, is to be reflected by the first belief space of the set of belief spaces associated with at least the first digital artifact. The method further includes determining, by the processing circuitry, based on the intent of the first event request, the set of acceptance criteria associated with the first event request. The method further includes executing, by the processing circuitry, the evaluation process associated with the first event request in accordance with the set of acceptance criteria. The method further includes generating, by the processing circuitry, the evaluation response based on the execution of the evaluation process. The evaluation response is indicative of one of: the approval of the first event request or the rejection of the first event request.

In another embodiment of the present disclosure, a computer-readable medium is provided. The computer-readable medium comprises instructions that, when executed by processing circuitry of a computing system, cause the computing system to perform a method for implementing a consensus framework for managing the set of belief spaces. The method includes receiving the first event request associated with at least the first digital artifact of the set of digital artifacts stored in the storage element. The set of digital artifacts is associated with the set of belief spaces. The set of belief spaces is stored in the decentralized storage network. The first event request is indicative of the proposed change to at least the first digital artifact. The proposed change, when committed, is to be reflected by the first belief space of the set of belief spaces associated with at least the first digital artifact. The method further includes determining, based on the intent of the first event request, the set of acceptance criteria associated with the first event request. The method further includes executing the evaluation process associated with the first event request in accordance with the set of acceptance criteria. The method further includes generating the evaluation response based on the execution of the evaluation process. The evaluation response is indicative of one of: the approval of the first event request or the rejection of the first event request.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates a system environment of a blockchain-based belief space management system, consistent with disclosed embodiments of the present disclosure;

FIG. 2 is a block diagram that illustrates the blockchain-based belief space management system of the system environment of FIG. 1, consistent with disclosed embodiments of the present disclosure;

FIGS. 3A, 3B and 3C, collectively, illustrate a sequence diagram that depicts a process flow for consensus-based management of digital artifacts and associated belief spaces, consistent with disclosed embodiments of the present disclosure;

FIG. 4 shows an example computing system for carrying out the methods of the present disclosure, consistent with disclosed embodiments of the present disclosure; and

FIG. 5 illustrates a flowchart of a method for consensus-based management of digital artifacts and associated belief spaces, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

In software product management systems, various stakeholders (for example, developers, end users, security analysts, auditors, or the like) are often required to make decisions regarding digital artifacts, such as code modules, database schemas, system configurations, development strategies, or the like. However, such human-driven decision-making introduces significant challenges in the evolution and maintenance of a software product. Stakeholders may suggest changes that are malicious, technically unsound, or based on incomplete awareness of the current state and interdependencies of the digital artifacts. These flawed decisions can lead to corruption, degradation, or even complete failure of digital artifacts within the product’s software ecosystem, thereby jeopardizing the overall integrity of the software product.

The inherent complexity of the software product, characterized by intricate interdependencies among digital artifacts and frequently undocumented relationships between components, further amplifies these risks. Decisions made without comprehensive visibility into, or a thorough understanding of, these interconnections may have severe consequences. For instance, retiring a seemingly unused module could unintentionally disrupt important business processes that rely on it through hidden or indirect dependencies.

Conventionally, the adverse effects of such decisions are detected only after implementation, often surfacing during system testing, production deployment, or post-deployment operations. By this stage, the software product may already have suffered significant financial losses due to downtime, failed development efforts, or even the need to restart entire initiatives. Moreover, such errors may result in data loss, corruption of digital artifacts, or the erosion of institutional knowledge embedded in the product’s codebase.

Traditional reliance on human oversight and standard operating procedures has proven inadequate in addressing these issues, especially in high-stakes product management environments where failures carry substantial costs and opportunities for remediation are severely limited.

The present invention relates to systems and methods for managing digital artifacts and associated belief spaces of software products using blockchain-based consensus mechanisms. More specifically, the invention provides a decentralized governance framework that employs Byzantine-resilient validation protocols to ensure the integrity of digital artifact modifications while preventing malicious or erroneous human interventions that could compromise software product stability.

The system includes a storage element and processing circuitry coupled thereto. The processing circuitry is configured to perform multiple functions for digital artifact and belief space management. The processing circuitry receives event requests associated with digital artifacts, where each event request indicates a proposed change to a first digital artifact that, when committed, will be reflected in a belief space of the first digital artifact stored in a decentralized storage network (for example, a blockchain).

The processing circuitry determines acceptance criteria from a set of logic constraints based on an intent of received event requests. The intent may be determined by the processing circuitry by utilizing sophisticated intent analysis algorithms that evaluate a nature, scope, and potential impact of proposed modifications. The processing circuitry executes an evaluation process to evaluate the event request in accordance with the determined acceptance criteria while coordinating multiple validation agents and a simulator agent to assess the safety and appropriateness of the proposed change.

The processing circuitry generates an evaluation response indicating approval or rejection of the event request based on an outcome of the evaluation processes. Upon approval, the processing circuitry executes a set of operations associated with the approved event request and commits the proposed change to the first digital artifact. The processing circuitry further accesses and updates the belief space associated with the first digital artifact in the decentralized storage network to reflect the committed changes, ensuring that the system's understanding of digital artifact states remains current and accurate.

The system utilizes a sophisticated multi-agent architecture including a set of validator agents for evaluating proposed changes through parallel processing mechanisms, simulator agents for creating isolated testing environments using containerization and virtualization technologies, and orchestrator agents for coordinating consensus processes across distributed network nodes. The processing circuitry selects subsets of validator agents from the set of validator agents based on standard operating procedures and various rules included in the set of logic stores. The processing circuitry may provide evaluation constraints to simulator agents, which creates a simulation environment that mirrors actual system conditions pertaining to the first digital artifact and one or more digital artifacts associated therewith.

The subset of validator agents monitors execution of operations within the simulation environment, determining observations pertaining to the set of operations, output of the set of operations, and identifying collateral operational conditions that may affect one or more digital artifacts associated with the first digital artifact through syntactic or semantic associations. Each validator agent generates intermediate evaluation responses that are aggregated by the orchestrator agent. Each intermediate evaluation response may be indicative of an approval or a rejection of the event request by a corresponding validator agent of the subset of validator agents. The processing circuitry generates an evaluation response based on whether a count of approvals exceeds required thresholds, implementing Byzantine fault-tolerant protocols that ensure system integrity even when some validators act maliciously or erroneously.

The system maintains a set of belief spaces for the digital artifacts in the decentralized storage network associated with the system. The set of belief spaces captures probabilistic representations of digital artifact states through belief types and belief states, where belief types indicate specific attributes of digital artifacts and belief states represent current attribute conditions with associated confidence scores. The processing circuitry identifies subsets of belief types affected by committed changes based on operational context analysis and updates corresponding belief states.

The disclosed system addresses challenges associated with the management of the software product and the corresponding set of belief spaces where human decision-makers may propose changes that are technically incorrect, based on incomplete information, or potentially malicious in nature. The processing circuitry implements time-based controls by scheduling execution of approved operations based on predefined time intervals, receiving and evaluating override requests prior to execution deadlines, and updating scheduled operations based on override evaluations.

The system disclosed herein provides reversible accountability mechanisms through time-locked transactions that allow stakeholders to contest or challenge harmful decisions before they become permanent. The system allows the stakeholders to provide an override request to contest/challenge the approved event request. The override request may be evaluated to determine whether a challenge to the event request is valid. Based on the challenge being valid, the processing circuitry may postpone an execution of the set of operations associated with the event request or reject the event request.

In some embodiments, the processing circuitry handles conflicting event requests by determining when operations associated with the event requests conflict, generating priority scores for the event requests based on request sources and contexts. Subsequently, the processing circuitry may schedule execution of the operations associated with the event requests based on the priority scores of the event requests to ensure optimal resource utilization and conflict resolution.

In some embodiments, the system disclosed herein stores and utilizes logic constraints that govern both acceptance criteria determination and evaluation processes, enabling flexible yet controlled governance over modification procedures.

In some embodiments, the system disclosed herein employs the set of validator agents, one or more simulator agents, and the orchestrator agent. These agents operate as autonomous entities with specific capabilities and responsibilities, working collaboratively to ensure comprehensive evaluation of proposed changes to digital artifacts. Validator agents are responsible for analyzing and evaluating event requests based on predefined criteria and constraints, with each validator agent capable of assessing different aspects of proposed changes, including technical feasibility, security implications, and potential impacts on related digital artifacts.

Simulator agents create and manage isolated execution environments that mirror the actual conditions of the software product without affecting production digital artifacts, utilizing containerization and virtualization technologies to establish safe testing environments where proposed operations can be executed and their effects observed without risk to a live/actual system environment of the software product. The orchestrator agents execute coordination mechanisms that manage communication between different agents and select appropriate validator agents based on requirements of each event request, and facilitate information exchange between agents.

The evaluation process is conducted through a multi-stage workflow that ensures comprehensive assessment of proposed changes before implementation. When the processing circuitry receives an event request, it first determines the intent of the request and establishes acceptance criteria that will govern the evaluation process. Based on these criteria, the orchestrator agent selects a subset of validator agents from an available pool of validator agents, ensuring that the chosen validator agents possess the appropriate expertise for evaluating a type of change that is being proposed by way of the event request.

The simulator agent creates a controlled simulation environment that replicates a portion of the system environment of the software product, including digital artifacts that are to be modified/updated based on the event request and dependencies associated with such digital artifacts. The proposed operations are then executed within the simulation environment. Based on the execution, the validator agents assess various factors, including technical correctness, security implications, performance impacts, and compliance with established standards or policies. Based on this analysis, each validator generates an intermediate evaluation response indicating either approval or rejection of the proposed change, along with supporting rationale.

The orchestrator agent collects all intermediate evaluation responses and applies consensus rules to determine the final outcome. The system requires a minimum threshold of approvals before any change can be accepted, implementing Byzantine fault-tolerant protocols that ensure the integrity of the system environment associated with the software product, even when the event request is incorrect or malicious. If the count of approval responses exceeds the required threshold, the orchestrator generates a final evaluation response indicating approval of the event request. If the count of approval responses is less than the required threshold, the orchestrator generates a final evaluation response indicating rejection of the event request.

Key advantages of the disclosed system include elimination of single points of failure through decentralized consensus mechanisms, prevention of harmful changes through multi-party validation requirements that can be dynamically adjusted based on priority of the event request, enhanced auditability through immutable blockchain records with cryptographic verification, and improved decision-making accuracy through AI-driven impact analysis that considers both direct and collateral effects of proposed changes.

The system achieves significant performance improvements, including significant reduction in vulnerability to malicious attacks through distributed validation, a significant decrease in turn-around time for generation of decisions for approval/rejection of event requests, and exhibits scalability through distributed architecture that can handle increase of any size in loads evaluation of event requests for any number of digital artifacts associated with any number of software products. The conflict resolution mechanisms of the disclosed system intelligently prioritize competing requests based on source authority authentication and temporal precedence rules, while comprehensive feedback generation provides detailed technical reasoning for all decisions through automated analysis of intermediate validation outcomes.

This combination of advanced validation protocols, distributed consensus mechanisms, and intelligent conflict resolution makes the disclosed system particularly suitable for high-stakes software product management environments where the cost of erroneous decisions can result in substantial financial losses, system failures, or security breaches. Throughout the evaluation process, the system maintains detailed logs and generates comprehensive feedback explaining the reasoning behind each decision, providing transparency and auditability for all evaluation outcomes.

### Figure Description

In software product management, human-driven decisions about digital artifacts (e.g., code modules, databases, configurations) often introduce risks. These risks arise from malicious intent, technical errors, or incomplete understanding of stakeholders (for example, end users, developers, security analysts, or the like) regarding complex, interdependent, and often undocumented relationships between digital artifacts of a software product. Such flawed decisions can corrupt or break various processes associated with the software product. Typically, problems are detected only after costly implementation, during testing, deployment, or post-deployment, leading to financial losses, downtime, data corruption, and loss of institutional knowledge. Traditional reliance on human oversight and standard procedures is inadequate for managing these high-stakes scenarios.

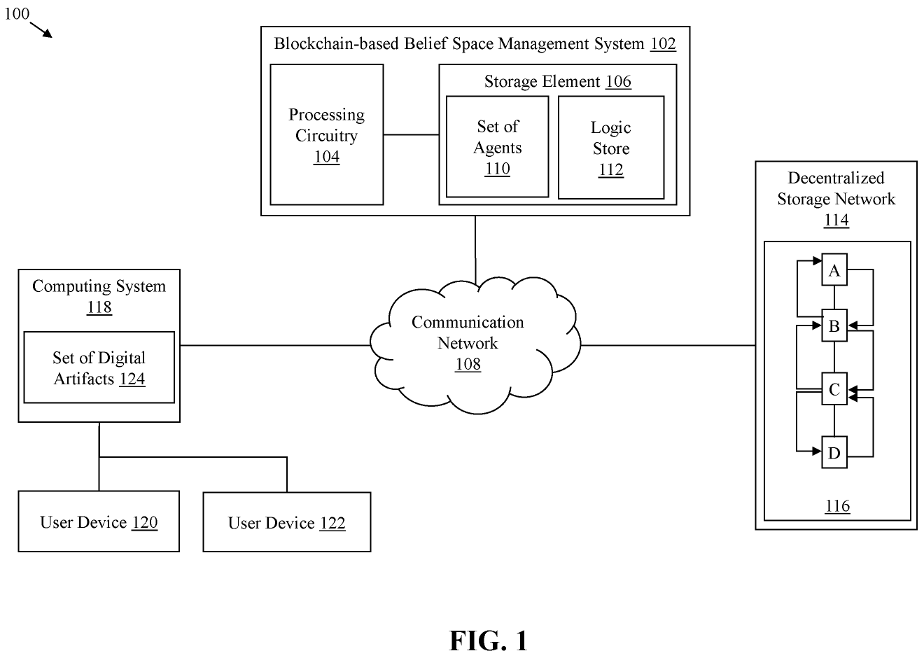

FIG. 1 is a schematic diagram that illustrates a system environment 100 of a blockchain-based belief space management system 102, consistent with disclosed embodiments of the present disclosure. The system (hereinafter, the blockchain-based belief space management system 102) provides for a distributed storage network-based consensus framework for management of belief spaces associated with a set of digital artifacts for a software product. The term ‘blockchain-based belief space management system 102’ is interchangeably referred to as the ‘system 102’.

Referring to FIG. 1, the system environment 100 is shown to include the blockchain-based belief space management system 102 having processing circuitry 104 and a storage element 106 communicatively coupled to the processing circuitry 104. In an embodiment, the processing circuitry 104 and the storage element 106 may be coupled via a communication bus (not shown).

In some embodiments, the blockchain-based belief space management system 102 may correspond to a distributed system. In such embodiments, the processing circuitry 104 and the storage element 106 may be implemented in a distributed environment. In some embodiments, the storage element 106 may be implemented as a cloud-based storage.

In some embodiments, the processing circuitry 104 and the storage element 106 may be communicably coupled via a communication network 108. The communication network 108 may act as a medium or communication channel between two or more components of the system environment 100. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, or a combination thereof.

The processing circuitry 104 may include suitable logic, circuitry, interfaces, and/or code, that when executed, may execute one or more operations associated management of belief spaces associated with the set of digital artifacts (for example, a set of code modules) of the software product, where the software product may correspond to a legacy software product or a modern software product. The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person skilled in the art that the processing circuitry 104 may be compatible with multiple operating systems. The processing circuitry 104 may further include one or more components (for example, a parser, a loader, or the like) that may be configured to execute one or more operations to be executed by the processing circuitry 104. In some embodiments, the processing circuitry 104 may be a single unit. Alternatively, in some embodiments, the processing circuitry 104 may be a combination of various modules configured to execute the one or more operations associated with the management of the set of belief spaces. Notably, the management of the set of belief spaces may be performed based on a management (for example, approval or rejection) of changes proposed to one or more digital artifacts of the set of digital artifacts associated with the digital artifact.

The storage element 106 may refer to a hardware or software component configured to store, but not limited to, a set of agents 110 and a logic store 112. The set of agents 110 and the logic store 112 in the storage element 106 may be accessed by the processing circuitry 104 for performing the management of the set of belief spaces associated with the set of digital artifacts. In an embodiment, the storage element 106 may further store one or more sets of digital artifacts associated with one or more additional software products that are to be visualized. The storage element 106 may include a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.), or any combination thereof. The storage element 106 may be locally or remotely associated with the processing circuitry 104.

The set of agents 110 may correspond to one or more artificial intelligence (AI) agents (for example, generative AI agents or agentic AI agents) that may be configured to execute one or more operations associated with the management of the set of belief spaces. The set of agents 110 may be utilized by the processing circuitry 104 for the execution of the one or more operations associated with the management of the set of belief spaces. The set of agents 110 may refer to a collection of autonomous or semi-autonomous computational modules, each configured to perform specific tasks or subtasks for execution of one or more operations associated with the management of the digital artifacts and belief spaces associated therewith. The set of agents 110 may include generative artificial intelligence (AI)-based agents and agentic AI-based agents. The generative AI-based agents may utilize generative models (such as large language models or diffusion models) to create content, generate responses, or synthesize data based on learned patterns whereas the agentic AI-based agents may be capable of goal-directed behavior, operate with a degree of autonomy, and may interact with other agents or components to plan, execute, and adapt actions in pursuit of defined objectives and goals, while exhibiting traits such as reasoning, decision-making, and feedback incorporation. Each agent of the set of agents 110 may operate independently or collaboratively with one or more other agents of the set of agents 110. In some embodiments, operations executed by each agent may be coordinated by the processing circuitry 104. In some embodiments, agents in the set of agents 110 may be coupled to each other and the logic store 112. In such embodiments, each agent of the set of agents 110 may interact with remaining agents of the set of agents 110 and may access the logic store 112.

The set of agents 110 may include, but is not limited to, a set of validator agents, one or more simulator agents, or an orchestrator agent. The set of agents 110 may execute the one or more operations associated with the management of the set of belief spaces sequentially or in parallelly. In some embodiments, the set of agents 110 may execute the one or more operations collectively to manage the set of belief spaces.

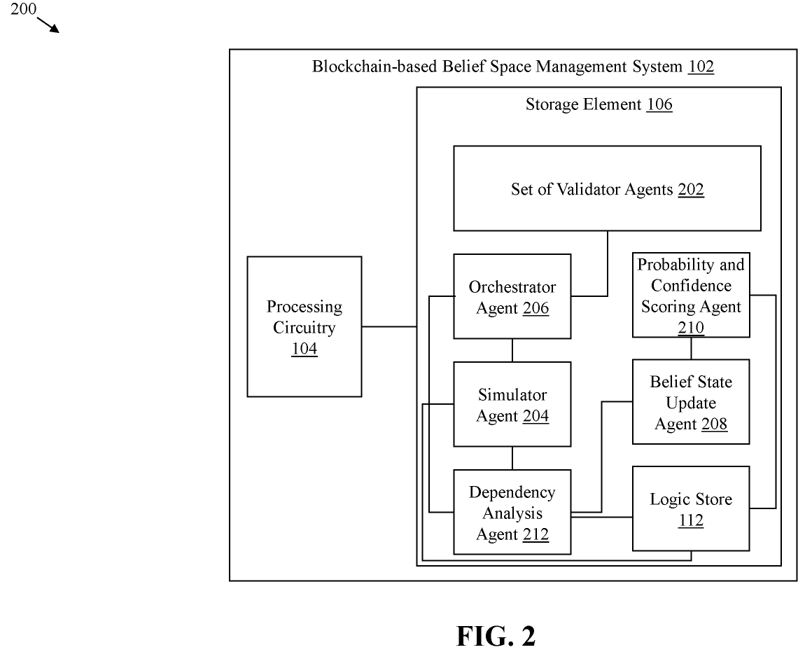

The processing circuitry 104 may further act as an orchestrator for the set of agents 110. For example, the processing circuitry 104 may be further configured to coordinate a sequence of operations executed by the set of agents 110. Each agent of the set of agents 110 may be configured to perform specific functions that, collectively, enable the management of the set of belief spaces. For the sake of brevity, the set of agents 110 is illustrated and described in detail in conjunction with FIG. 2.

The logic store 112 may include a set of constraints that correspond to computational elements such as rules, policies, constraints, heuristics, or machine-learned models that govern a consensus-based framework for the management of digital artifacts and corresponding belief spaces. The logic store 112 further comprises a set of logic constraints that correspond to a set of comprehensive rules that govern evaluation of event requests for any change that is proposed to be committed to the set of digital artifacts.

The set of logic constraints includes access control rules that verify whether a requesting entity possesses the necessary permissions to modify specific digital artifacts, such as ensuring a developer has write access to code repositories or confirming that a system administrator has authorization to modify configuration files.

The set of logic constraints further includes risk assessment constraints, which establish thresholds based on potential impact levels, for example, requiring additional validator agents when proposed changes exceed $10,000 in potential financial impact or mandating enhanced security reviews for modifications affecting payment processing modules.

The set of logic constraints further includes operational constraints that define temporal and resource-based limitations, such as preventing database schema changes during peak business hours or requiring rollback procedures to be in place before implementing changes to important system components.

The set of logic constraints further includes technical validation constraints, which specify requirements for dependency analysis, including rules that automatically identify related digital artifacts through syntactic associations (such as shared libraries or imported modules) and semantic associations (such as business logic dependencies between customer management and billing systems).

The set of logic constraints further includes consensus requirements which establish a minimum number/count of validator agents needed for evaluation or approval of an event request based on an impact of a proposed change associated with the first event request on the set of digital artifacts the software product, for example, requiring unanimous approval from three validators for changes to security protocols while allowing simple majority approval for documentation updates.

Additionally, the set of logic constraints includes temporal constraints that define time-based parameters such as 24-hour challenge periods for high-risk changes, allowing stakeholders to contest decisions before implementation, and cooling-off periods that prevent rapid successive modifications to the same digital artifact to ensure system stability.

The system 102 may be associated with a decentralized storage network 114 via the communication network 108. The decentralized storage network 114 corresponds to a blockchain-based infrastructure that maintains the set of belief spaces across multiple distributed nodes. Storage across multiple distributed nodes ensures tamper-proof storage and Byzantine fault tolerance for state information associated with the set of digital artifacts of the software product. In some embodiments, the decentralized storage network 114 utilizes a private blockchain architecture specifically designed for enterprise environments. The decentralized storage network 114 may implement a blockchain 116 that may store the set of belief spaces, where each block includes a belief space of the set of belief spaces. In addition, each block contains cryptographically hashed references to both previous and subsequent blocks, creating an immutable chain of belief space records that prevents unauthorized modifications or deletions. For example, a block B of the blockchain 116 includes a first cryptographically hashed reference to a block A of the blockchain 116, which is positioned before the block B in the blockchain 116. The block B further includes a second cryptographically hashed reference to a block C of the blockchain 116, which is positioned after the block B in the blockchain 116. Storage of cryptographically hashed references in various blocks of the blockchain 116 are depicted by way of various arrows connecting blocks A, B, C, and D of the blockchain 116.

The decentralized storage network 114 stores the set of belief spaces as structured data within blockchain transactions, where each belief space corresponds to a digital artifact of the set of digital artifacts and contains belief types representing functional, non-functional, and hidden attributes associated with the corresponding digital artifact, along with their associated belief states indicating current attribute values, probability, and confidence scores. For example, a belief space for a payment processing module might contain belief types such as "security_compliance" with a belief state of "PCI_DSS_certified" and confidence score of 0.95, or "performance_threshold" with a belief state of "sub_100ms_response" and confidence score of 0.87.

The decentralized nature of the decentralized storage network 114 ensures that no single point of failure can compromise the integrity of the set of belief spaces, with consensus mechanisms requiring approval of event requests before any belief state updates can be committed to the blockchain 116. The decentralized storage network 114 implements smart contracts that automatically validate belief state transitions based on predefined logic constraints, ensuring that only legitimate updates resulting from approved event requests can modify the stored belief spaces. Additionally, the decentralized storage network 114 maintains a complete audit trail of all belief state changes, enabling full traceability of how digital artifact attributes have evolved over time. The decentralized storage network 114 further provides forensic capabilities for investigating modifications or identifying the source of problematic changes associated with the set of digital artifacts.

The system 102 may be coupled to a computing system that implements the software product or the set of digital artifacts. Each of the plurality of entities associated with the set of digital artifacts may be further associated with the computing system via a corresponding user device. Further, one or more entities of the plurality of entities may be primed decision makers and may propose a change to be committed to one or more digital artifacts of the set of digital artifacts by way of corresponding user devices. Examples of a user device may include, but are not limited to, a laptop, a phone, a tablet, a phablet, or the like. The plurality of entities corresponds to various stakeholders associated with the set of digital artifacts that may act as primed decision makers for the set of digital artifacts. A primed decision maker (PDM) is a trusted human stakeholder with authorized privileges to propose changes to the set of digital artifacts, such as excluding legacy modules, overriding automated logic, or making high-stakes decisions that require human judgment and domain expertise in software product management scenarios. Examples of an entity may be an end user, a developer, a security analyst, a project manager, or the like.

As shown, the system 102 is associated with a computing system 118 via the communication network 108. The computing system 118 is shown to be associated with user devices 120 and 122 that may be associated with first and second entities, respectively, associated with the computing system 118. The computing system 118 is shown to be associated with a set of digital artifacts 124 associated with a first software product. The first and second entities may access the set of digital artifacts 124 via the user devices 120 and 122, respectively. Notably, the first and second entities may be associated with the first software product with different capacities, roles, and access permissions. At least one of the first entity and second entity may be associated with the first software product as a PDM and may propose changes to the set of digital artifacts 124. In some embodiments, the set of digital artifacts 124 may be stored in the storage element 106. It is assumed that the set of belief spaces stored by way of the blockchain 116 is associated with the set of digital artifacts 124.

Similarly, the system 102 may be coupled to one or more other computing systems (not shown) via the communication network 108. For the sake of brevity, the ongoing description is described with respect to the set of digital artifacts 124. It will be apparent to a person skilled in the art belief space management of any other set of digital artifacts may be performed in a similar manner.

In operation, the processing circuitry 104 may receive a first event request associated with at least a first digital artifact of the set of digital artifacts 124. The first event request is indicative of a proposed change to at least the first digital artifact. In an example, the proposed change may include modifications such as code updates, configuration alterations, or structural reorganizations. For example, in a legacy software modernization scenario, the first event request may correspond to a proposal to exclude an obsolete payment processing module or update database connection parameters.

Notably, when the proposed change is committed, it is to be reflected by a first belief space of the set of belief spaces, associated with the first digital artifact. The processing circuitry 104 may determine, based on an intent of the first event request, a set of acceptance criteria associated with the first event request. The intent of the first event request may refer to an underlying purpose, objective, and contextual meaning of a proposed change to the first digital artifact. The intent may be determined through automated analysis of content of the first event request, a scope of the first event request, and target components of the first event request. The content of the first event request includes data specifying the proposed change details, including target digital artifact identifiers, modification parameters, and operational instructions for implementing the proposed changes. The request content may further include metadata such as requester credentials, change justification, affected component specifications, and execution parameters that define how the proposed modifications should be applied to the identified digital artifacts. The intent encompasses a semantic understanding of what the requester aims to accomplish, including the type of change being proposed (such as code updates, configuration changes, or structural reorganizations), the rationale behind the change (such as bug fixes, performance improvements, or security enhancements), and an expected impact on the affected digital artifacts and their dependencies.

For example, an event request to modify a database connection string may have an intent of "configuration update for environment migration," while a request to remove a legacy payment module may have an intent of "obsolete component elimination for system modernization." The processing circuitry 104 may analyze the intent by examining request parameters, affected artifact types, proposed operation categories, and contextual metadata to classify the nature and scope of the proposed change. This intent analysis enables the processing circuitry 104 to determine a set of acceptance criteria associated with the first event request by selecting relevant logic constraints (for example, a first subset of logic constraints) from the set of logic constraints, and establishing suitable validation requirements tailored to the specific type of modification being requested. The intent serves as a foundation for risk assessment, where different intent categories may trigger varying levels of scrutiny, validation requirements, and approval thresholds based on the potential impact and complexity of the proposed change.

Notably, the set of acceptance criteria may correspond to one or more conditions and requirements that are to be satisfied or met before a first set of operations associated with the first event request may be executed. In some embodiments, the set of acceptance criteria may be determined based on the set of logic constraints stored in the logic store 112. The processing circuitry 104 may be configured to identify a first subset of logic constraints from the set of logic constraints based on the intent of the first event request. The first subset of logic constraints is identified from the set of logic constraints through automated filtering and matching algorithms that analyze the first event request's characteristics, target digital artifacts, and modification scope. The matching algorithms may select only those constraints that apply to the intent category of the first event request. The intent category corresponds to a type of change, for example, code modification, code addition, code deletion, or the like, that is to be committed to the set of digital artifacts 124. Different types of change may require different levels of scrutiny, which is governed by the set of constraints.

The first subset of logic constraints may correspond to a selected collection of validation rules, access control parameters, risk assessment thresholds, operational requirements, or the like that are relevant to the intent category of the first event request. Examples of logic constraints in the first subset of logic constraints may include, but are not limited to, security compliance rules for authentication module modifications or performance impact limits for database schema changes. The identified logic constraints are then used to determine the set of acceptance criteria by establishing concrete validation requirements, approval thresholds, and evaluation parameters that are to be met before the execution of the first set of operations associated with the first event request.

In some embodiments, the processing circuitry 104 may determine the set of acceptance criteria based on the first subset of logic constraints. The set of acceptance criteria may be used by the processing circuitry 104 for evaluation of the first event request. The set of acceptance criteria is indicative of at least one of: a count of validator agents required for the evaluation of the first event request, a count of validator agents required for approval of the first event request, or one or more evaluation constraints. The evaluation constraints may be associated with at least one of: the evaluation of the first event request or the execution of the first set of operations associated with the first event request. The evaluation constraints may correspond to conditions, limitations, and requirements that govern a process of evaluation of the first event request to be conducted, and a process of execution of the first set of operations is to be performed. The evaluation constraints ensure that proposed changes are assessed according to predefined standards and operational boundaries. The evaluation constraints may be associated with at least one of: the evaluation of the first event request, which defines parameters for how the assessment process itself must be conducted, or the execution of the first set of operations associated with the first event request, which establishes boundaries and requirements for how the proposed changes are implemented.

Examples of the evaluation constraints associated with the evaluation of the first event request include: mandatory simulation duration requirements that specify that the first set of operations is to be tested for a minimum of 24 hours before approval, validator expertise requirements that mandate at least one validator must possess specific domain knowledge relevant to the affected digital artifacts, consensus timing constraints that establish maximum deliberation periods for validator decision-making, and impact assessment scope requirements that require evaluation of all syntactically and semantically associated digital artifacts within a specified dependency radius.

Examples of evaluation constraints associated with the execution of the first set of operations include: rollback capability requirements that mandate the availability of automated recovery mechanisms before execution can proceed, resource utilization limits that restrict operations to specific time windows or system load thresholds, execution sequencing constraints that define an order in which the first set of operations is to be executed, backup verification requirements that ensure data preservation mechanisms are in place, performance impact boundaries that limit acceptable degradation levels during operation execution, and security isolation requirements that mandate that the first set of operations be performed within designated secure environments or with specific access controls activated.

The processing circuitry 104 may be further configured to execute an evaluation process associated with the first event request in accordance with the set of acceptance criteria. The processing circuitry 104 may perform the evaluation of the first event request based on the set of agents 110. The evaluation process may involve coordinating multiple validation mechanisms to assess safety, feasibility, and appropriateness of the proposed change. The evaluation process may be executed based on a second subset of the set of logic constraints. In some embodiments, the second subset of logic constraints may be determined based on the first set of logic constraints. In some embodiments, the second subset of logic constraints may be determined from the set of logic constraints but may be different from the first subset of logic constraints. The second subset of logic constraints may correspond to a sequence of operations, one or more rules, conditions, or the like that may be applied during execution of the first set of operations.

For the execution of the evaluation process, the processing circuitry 104 is configured to utilize the orchestrator agent to select a subset of validator agents from the set of validator agents. The subset of validator agents may be selected based on the set of acceptance criteria. A first count of validator agents in the subset of validator agents may be the same as the count of validator agents required for the evaluation of the first event request. The validator agents in the subset of validator agents may be configured to evaluate the first set of operations associated with the first event request. Subsequently, the processing circuitry 104 is configured to utilize the orchestrator agent to communicate with the simulator agent. The processing circuitry 104 may be configured to communicate, via the orchestrator agent, the second subset of logic constraints, the first event request (the content of the first event request), or the evaluation constraints to the simulator agent.

The simulator agent may be configured to create a simulation environment associated with the first digital artifact. The simulation environment associated with the first digital artifact may refer to an isolated computational framework or virtualized execution space. The simulation environment may replicate an operational context, dependencies, and runtime conditions of the first digital artifact, enabling safe testing and evaluation of the proposed change without affecting the software product. The simulation environment mirrors a current state, configuration, and behavioral characteristics of the first digital artifact, along with its related digital artifacts, dependencies, and operational parameters. The simulation environment may create a controlled testing space where the first set of operations associated with the first event request can be executed and their effects observed. The simulation environment may utilize containerization technologies, virtual machines, or sandbox architectures. The simulation environment may establish an isolated replica of operational environment, including associated databases, configuration files, network connections, and dependent services associated with the first digital artifact that would be affected by the proposed change. The simulation environment allows the simulator agent to execute the proposed change in a risk-free manner, generating a set of outputs and performance metrics that can be analyzed to assess potential impact, feasibility, and safety of implementing the proposed change in an actual system environment of the software product.

The simulator agent may be further configured to execute the first set of operations in the simulation environment. The first set of operations may be executed in the simulation environment in a manner that replicates an execution of the first set of operations in the actual system environment of the software product. The subset of validator agents may monitor the execution of the first set of operations in the simulation environment and determine a set of observations associated with the execution of the first set of operations. The first set of observations may be determined based on various performance metrics associated with the execution of the first set of operations and the set of outputs of the first set of operations.

The subset of validator agents may be further configured to identify a set of collateral operational conditions pertaining to a subset of digital artifacts of the set of digital artifacts. The set of collateral operational conditions may be caused due to the execution of the first set of operations. In addition, the set of collateral operational conditions may be caused by each digital artifact of the subset of digital artifacts being associated with the first digital artifact.

The set of collateral operational conditions refers to secondary changes, modifications, or state alterations that occur to one or more digital artifacts within the set of digital artifacts as a direct or indirect consequence of executing the first set of operations and committing the proposed change to the first digital artifact. These collateral conditions represent unintended or cascading effects that propagate through the system environment 100 of the software product. Examples of a collateral operational condition may include: (i) automatic recompilation or rebuilding of dependent digital artifacts that import or reference the first digital artifact, such as when updating a shared library causes dependent digital artifacts to require recompilation, (ii) invalidation or regeneration of cached data, configuration files, or derived artifacts that depend on the state or content of the first digital artifact, (iii) triggering of automated synchronization processes that update mirror systems, backup repositories, or distributed copies of related digital artifacts to maintain consistency, (iv) modification of metadata, index files, or registry entries that track relationships, dependencies, or version information associated with the affected digital artifacts, (v) activation of notification or alerting mechanisms that inform other digital artifacts or dependent digital artifacts about the change, potentially causing them to update their internal states or configurations, and (vi) cascading updates to documentation, deployment scripts, or configuration management systems that reference or depend upon the characteristics of the first digital artifact. These collateral operational conditions are identified through syntactic associations, such as direct code dependencies or file system references, and semantic associations, such as business logic relationships or functional interdependencies between system components.

The set of collateral operational conditions may be caused due to dependencies, associations, or interconnections between the first digital artifact and the one or more digital artifacts in the set of digital artifacts. The one or more digital artifacts may be associated with the first digital artifacts such that the association therebetween may be a syntactic association or a semantic association. A syntactic association corresponds to a structural or code-level relationship between digital artifacts based on direct technical dependencies, such as import statements, function calls, shared libraries, database foreign key relationships, or explicit references where one digital artifact directly invokes, includes, or depends upon another through programmatic or structural connections. A semantic association corresponds to a logical or functional relationship between digital artifacts based on conceptual dependencies, business logic connections, or operational interdependencies, such as digital artifacts that serve related business functions, process related data types, or participate in the same workflow processes, even when no direct structural connection exists between them.

The set of validator agents may perform the monitoring of the execution of the first set of operations, the determination of the set of observations, and the identification of the set of collateral operational conditions collectively or individually. That is to say that each validator may perform the monitoring of the execution of the first set of operations, the determination of the set of observations, and the identification of the set of collateral operational conditions. Alternatively, the set of validator agents may, collectively, perform the monitoring of the execution of the first set of operations, the determination of the set of observations, and the identification of the set of collateral operational conditions.

In some embodiments, the simulator agent may be configured to communicate the set of outputs to each of the subset of validator agents upon completion of the execution of the first set of operations in the simulation environment. The simulator agent may communicate the set of outputs to each of the subset of validator agents via the orchestrator agent.

Subsequently, each validator agent of the subset of validator agents may generate a corresponding intermediate evaluation response, which may be indicative of an approval or a rejection of the first event request. The intermediate event request may be generated based on the set of observations, the set of outputs, the set of collateral operational conditions, or the like. Each validator agent of the subset of validator agents operates as an independent evaluation entity that conducts comprehensive analysis of the proposed change by examining multiple information sources gathered during the execution of the first set of operations in the simulation environment. The validator agents assess the feasibility, safety, and appropriateness of the first event request by analyzing the set of observations collected during the execution of the first set of operations in the simulation environment, the set of outputs generated based on the execution of the first set of operations, and the set of collateral operational conditions that may affect related digital artifacts. Based on the multi-faceted analysis of the set of observations, each validator agent generates an intermediate evaluation response that represents its individual assessment of whether the proposed change should be approved or rejected, taking into account technical correctness, security implications, performance impacts, and compliance with established constraints.

In some embodiments, each validator agent of the subset of validator agents may be configured to evaluate a specific aspect (for example, technical correctness, security implications, performance impacts, compliance with established constraints, or the like) associated with the execution of the first set of operations in the simulation environment.

For example, in a legacy software modernization scenario where the first event request proposes removing an obsolete authentication module, three validator agents might generate different intermediate evaluation responses. Validator Agent A approves the request based on observations showing the module has zero active usage and outputs indicating successful authentication through alternative pathways. Validator Agent B rejects the request based on collateral operational conditions, showing that removing the module would break backward compatibility for legacy client applications still referencing the authentication interface. Validator Agent C approves the request based on observations confirming that all dependent systems have been successfully migrated to the new authentication framework and outputs demonstrating improved system performance without the obsolete module.

Subsequently, each validator agent of the subset of validator agents may communicate the corresponding intermediate evaluation response to the orchestrator agent. Hence, the evaluation process is executed. The orchestrator agent may be configured to receive the intermediate evaluation response from each validator agent of the subset of validator agents. A count of intermediate evaluation responses received by the orchestrator agent may be equal to the count of validator agents required for the evaluation of the first event request. The orchestrator agent may determine a count of intermediate evaluation requests that are indicative of the approval of the first event request. The orchestrator agent may compare the count of the intermediate evaluation requests that are indicative of the approval of the first event request with the count of validator agents required for the approval of the first event request.

The processing circuitry 104 generates an evaluation response based on the execution of the evaluation process. The evaluation response may be generated based on the intermediate evaluation responses received by the orchestrator agent. The processing circuitry 104 may generate the evaluation response by utilizing the orchestrator agent. The evaluation response may be indicative of one of: the approval of the first event request or the rejection of the first event request.

Based on the count of intermediate evaluation responses indicative of the approval of the first event being less than the count of validator agents required for the approval of the first event request, the evaluation response may be indicative of the rejection of the first event request. The processing circuitry 104 may reject the first event request. Subsequently, the first event request may be terminated.

Based on the count of intermediate evaluation responses indicative of the approval of the first event exceeding the count of validator agents required for the approval of the first event request, the evaluation response may be indicative of the approval of the first event request.

The orchestrator agent may be further configured to generate a set of feedback based on a first context associated with the evaluation response. The set of feedback is indicative of a set of reasoning pertaining to the evaluation response being indicative of one of: the approval of the first event request or the rejection of the first event request. In some embodiments, the orchestrator agent may include a feedback generation module that processes the second context data, which may include contextual parameters such as validator consensus patterns, simulation execution results, constraint compliance assessments, and collateral operation conditions evaluations. The feedback generation module may analyze the contextual parameters to produce structured feedback data, including reasoning elements such as validator agreement metrics, simulation outcome summaries, constraint violation identifications, and risk assessment conclusions.

For instance, when the evaluation response indicates approval of the first event request, the set of feedback may include reasoning such as "unanimous validator approval achieved (3/3 validators approved)", "simulation execution completed successfully with zero errors", "all security constraints satisfied including access control validation", and "collateral operational conditions identified as minimal impact on 2 dependent digital artifacts". The feedback may further include performance metrics such as "simulation execution time: 45 seconds" and "resource utilization within acceptable thresholds (memory: 78%, CPU: 62%)".

Conversely, when the evaluation response indicates rejection, the set of feedback may include reasoning such as "insufficient validator consensus (1/3 validators approved, 2/3 rejected)", "simulation execution revealed dependency failure in payment processing module", "constraint violation detected: proposed change exceeds maximum allowable risk threshold of 0.3", or "collateral operational conditions indicate potential system-wide performance degradation affecting 15 related digital artifacts". The set of reasonings may also include specific technical details such as "validator Agent A rejected due to security vulnerability CVE-2023-1234 detected in modified authentication logic" or "simulator agent identified database connection timeout errors during stress testing phase".

Based on the evaluation response being indicative of the approval of the first event request, the processing circuitry 104 may execute the first set of operations associated with the first event request in the actual system environment associated with the set of digital artifacts 124. The execution of the first set of operations may comprise the actual implementation steps required to effectuate the proposed change, such as modifying code files, updating database records, or reconfiguring system parameters. The processing circuitry 104 may commit, based on the execution of the first set of operations, the proposed change to the first digital artifact. The execution process may include implementing one or more modification procedures defined in the first set of operations, such as applying code changes to source files, updating configuration parameters, modifying database schemas, or restructuring digital artifact components according to the approved event request. The execution may involve sequential processing of individual operation steps of the first set of operations, resource allocation for computational tasks, temporary file creation for intermediate results, and real-time monitoring of operation progress to ensure successful completion of each modification step. Such completion of the execution of the first set of operations may correspond to commitment of the proposed change to the first digital artifact.

Following the commitment of the proposed change, the processing circuitry 104 may access a first belief space, associated with the first digital artifact, in the decentralized storage network 114. The first belief space may be accessed based on a change in a current state of the first digital artifact due to the commitment of the proposed change. The processing circuitry 104 may be further configured to update the first belief space based on the commitment of the proposed change to the first digital artifact. The first belief space may be updated to reflect an updated state of the first digital artifact that is caused due to the commitment of the proposed change to the first digital artifact. The first belief space corresponds to a set of belief types associated with a set of belief states. A first belief type of the set of belief types is indicative of a first attribute associated with the first digital artifact, and a first belief state of the set of belief states is associated with the first belief type and indicative of a current state of the first attribute. For example, in a software modernization system, the first digital artifact may be a legacy payment processing module, the first attribute may be "security compliance," the first belief type may be "PCI_DSS_compliance_status," and the first belief state may indicate "currently non-compliant with PCI DSS version 4.0 requirements" with an associated confidence score of 0.92. In another example, the digital artifact could be a database configuration file, the attribute could be "performance optimization," the belief type could be "query_execution_efficiency," and the belief state could indicate "currently optimized for high-throughput operations" with a probability of 85% and a confidence score of 0.78. Additionally, for a code module digital artifact, the attribute may be "maintainability," the belief type could be "code_complexity_assessment," and the belief state could indicate "currently exhibits high cyclomatic complexity requiring refactoring" with a probability of 89% and a confidence score of 0.85. In a further example, a digital artifact representing an application programming interface (API) endpoint might have an attribute of "availability," a belief type of "uptime_reliability," and a belief state indicating "currently maintaining 99.7% uptime over the past 30 days" with a probability of 95% and a confidence score of 0.95.

For the update of the first belief space, the processing circuitry 104 may identify, based on a second context of the first set of operations, a subset of belief types of the set of belief types. The subset of belief types corresponds to one or more attributes associated with at least the first digital artifact, with a change in corresponding current states based on the commitment of the proposed change. The processing circuitry 104 may update a subset of belief states of the set of belief states associated with the subset of belief types based on a set of outputs of the first set of operations. For the update of the first belief space, the processing circuitry 104 may implement a contextual analysis algorithm that processes a second context of the first set of operations to systematically identify a subset of belief types from the set of belief types associated with the first belief space. The second context may be indicative of operational metadata, the set of outputs, performance metrics, the set of observations, the set of collateral operational conditions, and impact assessment data generated during the execution of the first set of operations. The contextual analysis may utilize pattern-matching algorithms, dependency mapping techniques, and attribute correlation analysis to determine which belief types are affected by the implemented changes to the first digital artifact. The subset of belief types may correspond to one or more attributes associated with the first digital artifact that experience modifications in their corresponding current states as a direct consequence of the commitment of the proposed change to the digital artifact structure, content, or configuration.

The processing circuitry 104 may execute a belief state update process that modifies a subset of belief states within the set of belief states, wherein each belief state in the subset is associated with a corresponding belief type from the identified subset of belief types. The update process may be based on the set of outputs generated by the first set of operations, where the set of outputs may include measurable results, performance indicators, validation confirmations, and operational status data that reflect an actual impact of the implemented changes. The belief state update mechanism may utilize probabilistic computation algorithms to recalculate confidence scores, state transition functions to modify attribute values, and temporal tracking systems to record the timing and context of belief state modifications. The updated belief states may reflect new attribute conditions such as modified security compliance levels, altered performance characteristics, updated dependency relationships, or changed operational status indicators that accurately represent the current state of the first digital artifact following the successful commitment of the proposed change.

For the sake of brevity, the first event is assumed to be associated with the proposed change to the first digital artifact. In other embodiments, the first event may be further associated with one or more additional proposed changes to one or more other digital artifacts of the set of digital artifacts 124.

In some embodiments, the processing circuitry 104 may receive a second event request associated with the first digital artifact and/or a second digital artifact of the set of digital artifacts 124 in a manner similar to the reception of the first event request. The second event request may include similar structural elements, including proposed change specifications, target digital artifact identifiers, and operational parameters that define the scope and nature of the requested modifications as described in conjunction with the first event request. The processing circuitry 104 may determine that the first set of operations associated with the first event request conflicts with a second set of operations associated with the second event request through automated conflict detection algorithms that analyze operational dependencies, resource requirements, timing constraints, and target digital artifact overlaps. The conflict determination may further involve dependency graph analysis, resource allocation assessment, and temporal scheduling evaluation to identify potential interference patterns between the competing operational sequences.

In an example, the first set of operations associated with the first event request may involve updating a database schema by adding new columns to a customer table, while the second set of operations associated with the second event request may involve restructuring the same customer table by removing existing columns and modifying data types. Therefore, the first and second sets of operations conflict as the first and second sets of operations may not be executed concurrently without causing data integrity issues, schema corruption, or system instability.

In another example, an operational conflict may occur when the first set of operations requires exclusive access to a shared configuration file to modify authentication parameters, while the second set of operations simultaneously attempts to update security settings in the same configuration file. The conflict between the first and second sets of operations may occur as each of the first and second sets of operations requires write access to the same digital artifact, and concurrent modifications could result in data corruption, inconsistent system states, or loss of configuration integrity.

Additionally, a resource-based conflict may occur when the first set of operations may involve high-intensity computational tasks that consume significant system resources during execution, while the second set of operations may require similar resource allocation for parallel processing tasks. The conflict manifests as insufficient capacity of the computing system 118 to execute both operations simultaneously without degrading performance below acceptable thresholds or causing instability to the computing system 118 due to resource exhaustion.

For conflict resolution, the processing circuitry 104 may generate, for each of the first event request and the second event request, a corresponding priority score through a multi-factor scoring algorithm that evaluates request characteristics, source authority levels, and contextual parameters. A first priority score and a second priority score associated with the first event request and the second event request may be generated based on a first source of the first event request and a second source of the second event request, respectively, wherein the source evaluation may include authentication verification, authorization level assessment, and historical reliability metrics associated with each requesting entity. The priority scoring mechanism may further incorporate factors such as request urgency indicators, potential impact assessments, resource availability considerations, and temporal precedence rules to establish relative importance rankings between competing requests.

The processing circuitry 104 may schedule execution of at least one of the first set of operations or the second set of operations based on the first and second priority scores through a scheduling algorithm that optimizes resource allocation and minimizes operational conflicts. The scheduling process may involve temporal sequencing, resource reservation, and execution queue management to ensure that higher-priority operations receive precedence while maintaining stability and performance characteristics of the computing system 118 and/or the software product. This conflict resolution mechanism executed by the processing circuitry 104 may implement various scheduling strategies, including sequential execution, parallel processing with resource partitioning, or conditional execution based on dependency resolution outcomes. The conflict resolution mechanism ensures optimal resource utilization and conflict resolution in multi-request scenarios while maintaining integrity and operational efficiency of the computing system 118 and/or the software product.

It will be apparent to a person skilled in the art that the system environment 100 shown in FIG. 1 is exemplary and does not limit the scope of the description.

FIG. 2 is a block diagram 200 that illustrates the blockchain-based belief space management system 102 of the system environment 100 of FIG. 1, consistent with disclosed embodiments of the present disclosure. For the sake of brevity, FIG. 2 is explained in conjunction with elements from FIG. 1. Referring to FIG. 2, the system 102 is shown to include the processing circuitry 104 that is coupled to the storage element 106 as described in conjunction with FIG. 1.

As mentioned previously, the storage element 106 is configured to store the set of agents 110 (shown in FIG. 1) and the logic store 112. The set of agents 110 may include the set of validator agents (hereinafter, the set of validator agents 202), the simulator agent (hereinafter, the simulator agent 204), the orchestrator agent (hereinafter, the orchestrator agent 206), a belief state update agent 208, a probability and confidence scoring agent 210, and a dependency analysis agent 212.

A validator agent of the set of validator agents 202 may refer to a specialized agentic AI software component stored within the storage element 106 that functions as an autonomous evaluation entity configured to assess the feasibility, safety, and compliance of proposed changes to digital artifacts. The validator agent may perform operations including receiving and analyzing an event request along with associated simulation outputs, monitoring execution of operations associated with the event request within simulation environments to collect observational data, evaluating proposed changes against a determined acceptance criteria and logic constraints, and generating intermediate evaluation responses that indicate either approval or rejection of the event request. The validator agent may further execute dependency analysis operations to identify collateral operational conditions that affect syntactically or semantically associated digital artifacts. The validator agent may further apply domain-specific validation logic based on technical expertise areas such as security compliance or performance optimization, and communicate evaluation results and supporting rationale to the orchestrator agent 206 through structured data interfaces.

The validator agent may make autonomous decisions regarding evaluation methodologies, dynamically adjust its assessment criteria based on contextual factors and historical performance data, and adaptively tweak its operational parameters to optimize evaluation accuracy for different types of event requests. Additionally, the validator agent may participate in distributed consensus mechanisms by contributing individual assessment outcomes that are aggregated with other validator agents to achieve collective decision-making, maintain operational independence while coordinating with other system components, learn from previous evaluation outcomes to refine future decision-making processes, and adapt evaluation criteria based on dynamic constraint updates or changing requirements. The validator agent operates within a multi-agent validation framework where multiple validator agents collectively assess event requests through parallel processing mechanisms to ensure comprehensive evaluation coverage and Byzantine fault-tolerant consensus for digital artifact modification decisions.

The byzantine fault tolerance consensus refers to a distributed system's (for example, the system 102) capability to achieve consensus and maintain correct operation even when up to one-third of the participating nodes/PDMs exhibit arbitrary failures, including malicious behavior, communication errors, or complete system failures. The consensus based primed consensus framework disclosed herein ensures reliable decision-making in environments where human Primed Decision Makers (PDMs) or AI validator agents may act erroneously, maliciously, or become compromised, particularly in high-stakes scenarios where incorrect decisions could result in system-wide failures or security breaches.

The use of a Byzantine fault tolerant protocol results in system integrity by requiring consensus among multiple validator agents before approving any proposed changes to digital artifacts, thereby preventing any single malicious or faulty validator from corrupting the belief space or approving harmful modifications. The protocol ensures that as long as fewer than one-third of the validator agents are compromised, the system 102 can still reach correct consensus decisions through cryptographic verification, distributed validation, and majority agreement mechanisms. This mathematical guarantee of fault tolerance is significant for maintaining the integrity of the decentralized storage network 114 and protecting against insider attacks, human errors, or AI agent malfunctions that could otherwise compromise the software product.

The Byzantine fault tolerant implementation addresses the technical problem of trust in distributed human-AI collaborative systems by eliminating single points of failure and ensuring that no individual actor can unilaterally alter critical system states, thereby providing the robust governance framework necessary for enterprise-level legacy code modernization deployments.

The simulator agent 204 may refer to a specialized software component stored within the storage element 106 that functions as an autonomous testing entity configured to create and manage isolated execution environments for safe evaluation of proposed changes to digital artifacts. The simulator agent 204 may perform operations including receiving event requests, acceptance criteria, and evaluation constraints from the orchestrator agent 206, creating simulation environments that replicate the operational context and dependencies of target digital artifacts. The simulator agent 204 may further execute operations associated with the proposed changes within controlled testing spaces of the simulation environments without affecting the actual system environment associated with the software product. The simulator agent 204 may communicate with one or more validator agents of the set of validator agents 202 (optionally, via the orchestrator agent 206) for enabling execution of monitoring operations to observe the behavior and performance of digital artifacts during simulated implementation of the proposed changes, generation of comprehensive output data including performance metrics, error logs, and system state information resulting from the simulated execution of operations associated with the proposed changes.

The simulator agent 204 may communicate outputs of the simulated execution of operations associated with the proposed changes to the orchestrator agent 206 for distribution to the one or more validator agents. Additionally, the simulator agent 204 may perform environment management operations such as initializing virtual execution spaces with appropriate configurations, dependencies, and runtime conditions that mirror actual system environments of the software product, maintaining isolation boundaries to prevent simulation activities from impacting actual digital artifacts, and cleaning up simulation resources upon completion of testing activities. The simulator agent 204 may operate by utilizing containerization technologies, virtual machines, or sandbox architectures to establish secure testing environments, implementing rollback mechanisms to restore simulation environments to initial states between test runs, and providing detailed observational data that enables the validator agents to assess the potential impact and feasibility of the proposed changes before implementation in the actual system environment of the software product.

The orchestrator agent 206 may refer to a specialized software component stored within the storage element 106 that functions as a central coordination entity configured to manage and facilitate the consensus-based evaluation process for the event requests within the multi-agent validation framework. The orchestrator agent 206 may perform operations including receiving event requests from the processing circuitry 104 and determining appropriate acceptance criteria based on the intent and associated logic constraints, selecting and coordinating subsets of validator agents based on required counts of validator agents and domain expertise requirements, and communicating event requests along with evaluation constraints to simulator agents for testing execution. The orchestrator agent 206 may further execute coordination operations such as distributing simulation outputs from the simulator agent 204 to selected validator agents for evaluation, collecting intermediate evaluation responses from multiple validator agents participating in the evaluation process, and aggregating these responses to determine whether the required count of validator agents approving the proposed changes has been met for the generation of the evaluation response.

In one embodiment, the orchestrator agent 206 may perform consensus management operations, including implementing Byzantine fault-tolerant protocols to ensure system resilience against malicious or erroneous validator responses, generating comprehensive feedback that explains the reasoning behind approval or rejection decisions based on validator inputs and constraint compliance assessments, and managing conflict resolution processes when multiple event requests compete for system resources or target overlapping digital artifacts. The orchestrator agent 206 may operate as a central hub within the distributed validation architecture, maintaining communication channels with all system components, enforcing procedural compliance with established governance protocols, and ensuring that the collective decision-making process adheres to predefined acceptance criteria while providing transparency and auditability through structured feedback generation mechanisms.

As mentioned previously, the processing circuitry 104 may maintain the set of belief spaces associated with the set of digital artifacts 124 in the decentralized storage network 114 associated with the system 102. The processing circuitry 104 may utilize the belief state update agent 208 of the set of agents 110 for maintenance of the set of belief spaces. The set of belief spaces includes the set of belief types, and each belief type is associated with the corresponding belief state of the set of belief states that indicate the current state of specific attributes of digital artifacts within that belief type category. A belief space associated with a first digital artifact may include a first set of belief types associated with a first set of belief states. A first belief state of the first set of belief states may be associated with a first belief type of the first set of belief types, with the first belief type being indicative of a first attribute pertaining to the first digital artifact. The first belief state may represent a probabilistic or deterministic assessment of condition, status, or characteristic of the first digital artifact with respect to the first attribute. Such representation of the set of digital artifacts 124 by way of the set of belief spaces enables the system 102 to maintain a comprehensive understanding of an ecosystem of the set of digital artifacts 124.

In some embodiments, the processing circuitry 104 may be configured to utilize the belief space update agent 208, which is an AI-based system employing artificial intelligence algorithms to identify and update a first belief space of the set of belief spaces associated with the first digital artifact based on the commitment of the proposed change to the first digital artifact. The belief space update agent 208 may access the decentralized storage network 114 via the communication network 108 for the identification of the first belief space. The belief space update agent 208 may be further configured to determine a subset of belief types from a first set of belief types associated with the first belief space. The determination may be based on the context of the first set of operations. For example, in case, the context of the first set of operations indicates that the proposed change intends to commit a code change to the first digital artifact. Therefore, a code commit belief type and/or a performance hotspot belief type may be selected from the first set of belief types. The belief space update agent 208 may be further configured to update a corresponding set of belief states associated with the subset of belief types.

The processing circuitry 104 may further utilize the probability and confidence scoring agent 210 that may be an AI-based system employing one or more algorithms to calculate and assign numerical probability scores and confidence scores to belief states associated with belief types of a digital artifact of the set of digital artifacts 124. The probability and confidence scoring agent 210 may be implemented as agentic AI-based systems that may operate autonomously to evaluate the likelihood and reliability of various system states, artifact associations, and user preferences. The probability and confidence scoring agent 210 may possess goal-directed behavior focused on providing accurate quantitative assessments of uncertainty and reliability. The probability and confidence scoring agent 210 may be configured to calculate and update probability and confidence scores for a set of belief states (for example, the first subset of belief states) using advanced probabilistic modeling (e.g., Monte Carlo simulations, Bayesian inference). The probability and confidence scoring agent 210 further sends the probability or confidence scores to the belief state update agent 208 to update corresponding belief states.

The dependency analysis agent 212 may be configured to generate a dependency graph that may depict associations (for example, semantic associations and syntactic associations) among two or more digital artifacts of the set of digital artifacts 124. The dependency analysis agent 212 may enable the processing circuitry 104 to identify the semantic associations or the syntactic associations between digital artifacts.

The dependency analysis agent 212 may be an AI-based system that employs artificial intelligence algorithms to analyze, map, and maintain complex interdependencies between digital artifacts. The dependency analysis agent 212 may be implemented as an agentic AI-based component that may operate autonomously to discover both direct and indirect relationships between digital artifacts, trace impact propagation paths, and update the dependency graph to reflect the relationships between digital artifacts and impact propagation among the digital artifacts. The dependency analysis agent 212 may possess goal-directed behavior focused on maintaining comprehensive and accurate dependency mappings by way of the dependency graph. The dependency analysis agent 212 uses decision-making capabilities to determine the significance and type of associations between the digital artifacts (semantic or syntactic associations). The dependency analysis agent 212 may use adaptive learning mechanisms to continuously refine dependency detection accuracy through analysis of user behavior patterns and user interactions. The set of validator agents 202 may determine collateral operational conditions associated with execution of proposed changes based on the dependency graph or by interacting with the dependency analysis agent 212 that may generate the collateral operational conditions.

In some embodiments, the processing circuitry 104 may be further configured to train one or more agents of the set of agents 110 based on corresponding training data. The training may be performed for a training time interval. The training of each of the set of agents 110 may be performed based on one or more training algorithms (for example, few-shot learning, supervised learning, unsupervised learning, or the like) known in the art. The processing circuitry 104 may be further configured to store the set of agents 110 in the storage element 106. The processing circuitry 104 may be further configured to access the set of agents 110 from the storage element 106. Operations executed by each of the set of agents 110 may actually be executed by the processing circuitry 104 by utilizing the set of agents 110.

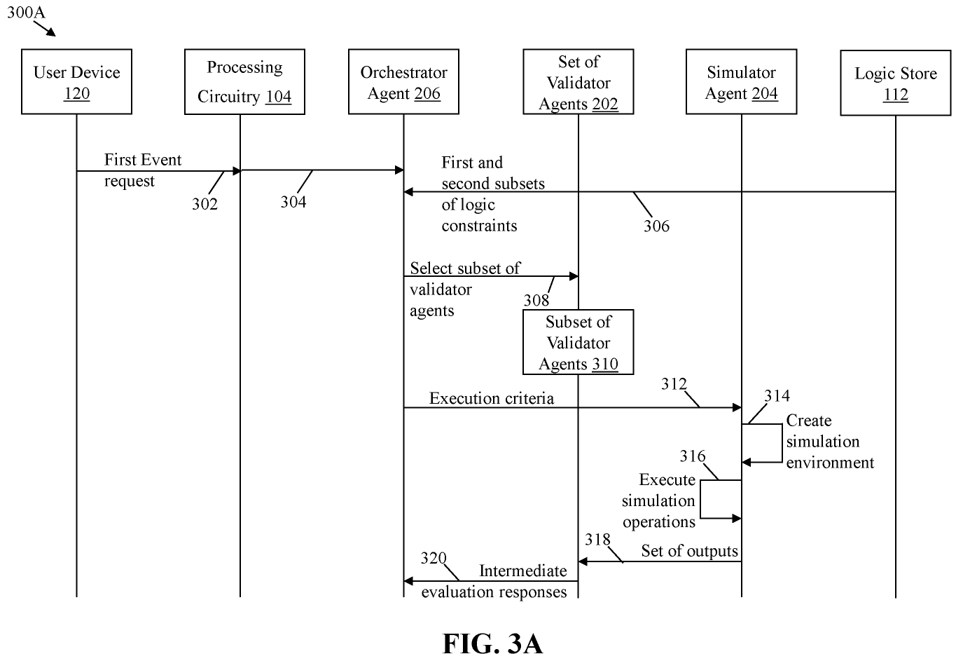

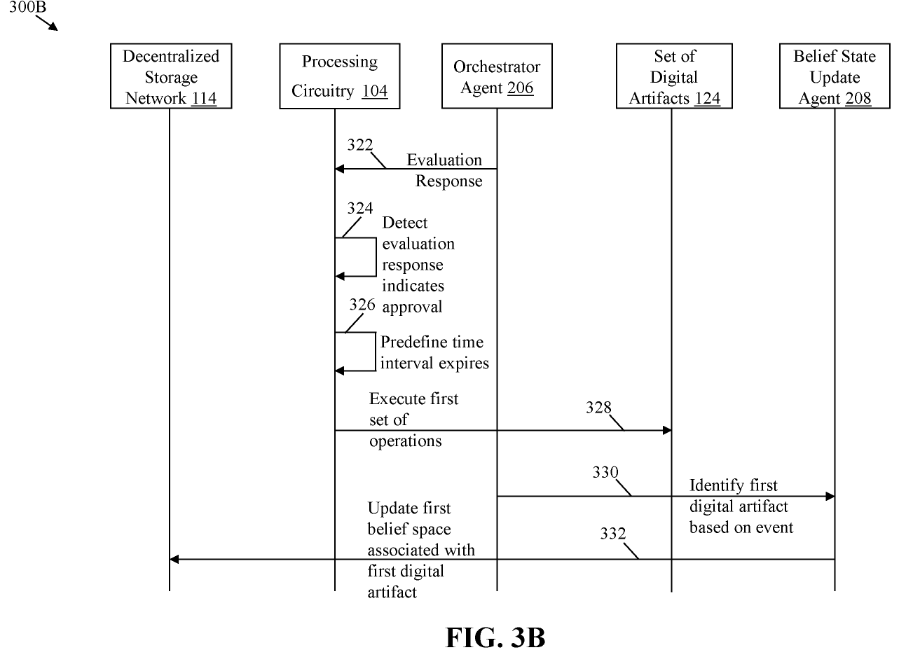

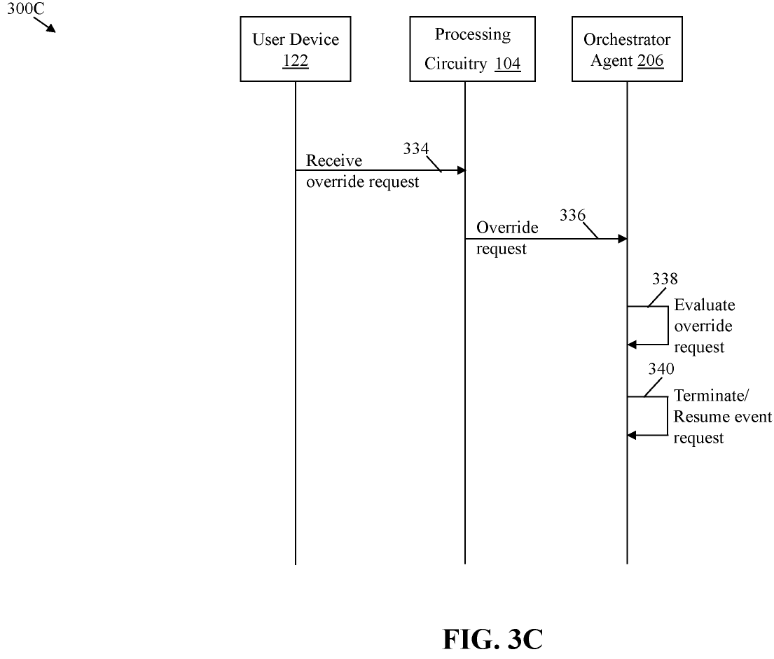

FIGS. 3A, 3B, and 3C collectively, illustrate a sequence diagram 300 that depicts a process flow for consensus-based management of digital artifacts and associated belief spaces, consistent with disclosed embodiments of the present disclosure. Referring to FIG. 3A, a first PDM (Primed Decision Maker) device (for example, the user device 120) may initiate the first event request for modification of the first digital artifact. At 302, the first event request may be received by the processing circuitry 104 from the first PDM device. The first event request may be indicative of the proposed change to the first digital artifact of the set of digital artifacts 124.

At 304, the processing circuitry 104 may communicate the first event request to the orchestrator agent 206. At 306, the orchestrator agent 206 may determine the first subset of logic constraints and the second subset of logic constraints from the set of logic constraints stored in the logic store 112. The orchestrator agent 206 may determine the set of acceptance criteria based on the intent of the first event request and the first subset of logic constraints as described in conjunction with FIG. 1.

At 308, the orchestrator agent 206 may select, based on the acceptance criteria, the subset of validator agents (hereinafter, the subset of validator agents 310) from the set of validator agents 202. The selection is based on the count of validator agents required for the evaluation of the first event request and domain expertise requirements for the proposed change associated with the first event request.

At 312, the orchestrator agent 206 may communicate the execution criteria to the simulator agent 204 for controlled testing of the proposed changes. At 314, the simulator agent 204 may create the simulation environment associated with the first digital artifact as described throughout the description. The simulation environment replicates an operational context and dependencies of the first digital artifact.

At 316, the simulator agent 204 may execute the first set of operations associated with the first event request within the simulation environment. The execution may be monitored by the subset of validator agents 310. The simulator agent 204 may generate, based on the execution, the set of observations and the set of outputs. At 318, the simulator agent 204 may communicate the set of outputs, along with the set of observations, performance metrics, and operational data, to the orchestrator agent 206.

At 320, the orchestrator agent 206 may distribute the set of outputs to the subset of validator agents 310 for comprehensive evaluation. Each validator agent in the subset of validator agents 310 may analyze the set of results, the set of observations, performance metrics, operational data, and the set of collateral operational conditions to generate corresponding intermediate evaluation responses indicative of approval or rejection of the first event request. At 320, each of the subset of validator agents 310 may communicate corresponding intermediate evaluation responses to the orchestrator agent 206 for consensus processing.

Referring now to FIG. 3B, the orchestrator agent 206 may generate the evaluation response based on the intermediate evaluation responses. At 322, the orchestrator agent 206 may communicate the evaluation response to the processing circuitry 104. At 324, the processing circuitry 104 may detect that the evaluation response may be indicative of the approval of the first event request. Based on the evaluation response being indicative of the approval of the first event request, the processing circuitry 104 may schedule the execution of the first set of operations associated with the first event request based on an expiration of a predefined time interval. The predefined time interval may correspond to a wait time for which the processing circuitry 104 may wait before the execution of the first set of operations. The wait time may be allocated for a probable reception of an override request for challenging the approval, authenticity, validity, or feasibility of the first event request. The override request may be associated with a third context thereof, which may include one or more reasons for establishing the approval, authenticity, validity, or feasibility of the first event request as untrustworthy or harmful to the software product associated with the set of digital artifacts 124. At 326, the processing circuitry 104 may detect the expiration of the predefined time interval. Examples of the predefined time interval may include, but are not limited to, 1 hour, 2 hours, 3 hours, 4 hours, 5 hours, 10 hours, 15 hours, 20 hours, and so on. A value of the predefined time interval may be dependent on complexity, importance, and/or impact of the first set of operations with respect to the set of digital artifacts 124.

At 328, the processing circuitry 104 may execute the first set of operations associated with the first event request. Based on the execution of the first set of operations, the proposed change may be committed to the first digital artifact. At 330, the orchestrator agent 206 may coordinate the belief state update agent 208 to access the decentralized storage network 114 and update the first belief space associated with the first digital artifact. At 332, the belief state update agent 208 may access the decentralized storage network 114 and update the first belief space associated with the first digital artifact as described in conjunction with FIG. 1.

Referring now to FIG. 3C, at 334, prior to the detection of the expiration of the predefined time interval at 326, the processing circuitry 104 may receive the override request from a second PDM device (for example, the user device 122). At 336, the processing circuitry 104 may communicate the override request to the orchestrator agent 206. At 338, the orchestrator agent 206 may evaluate the override request based on the third context thereof. The third context may include the one or more reasons for establishing the approval, authenticity, validity, or feasibility of the first event request as untrustworthy or harmful to the software product associated with the set of digital artifacts 124. Based on the evaluation of the override request being indicative of the reasons for challenging the approval to the first event request being valid, at 340, the processing circuitry 104 may update the scheduled execution of the first set of operations by one of (i) delaying the execution, (ii) resuming (restarting) the execution, or (iii) terminating the execution. The processing circuitry 104 may terminate the scheduled execution of the first set of operations by withdrawing the approval to the first event.

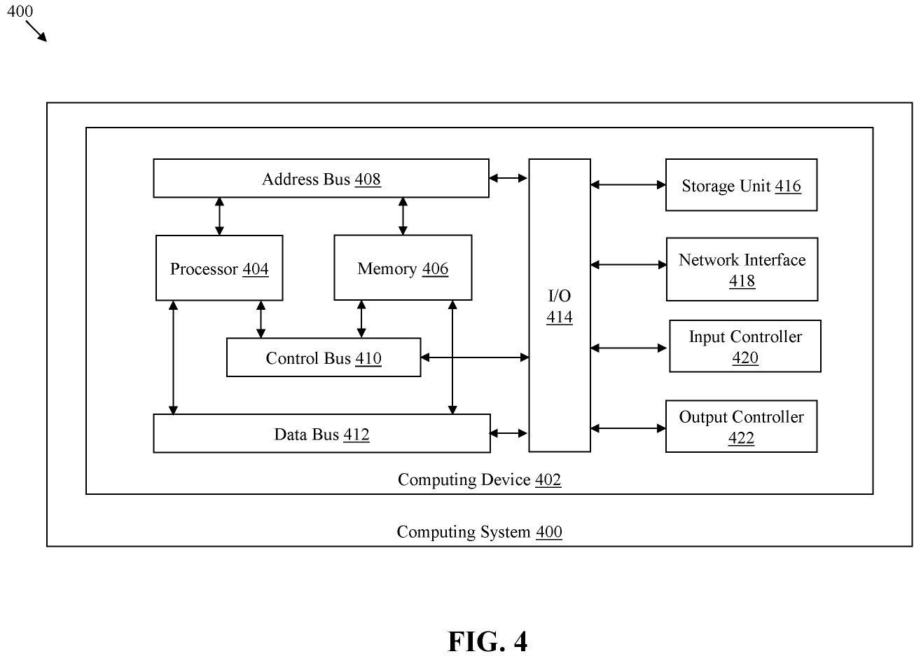

FIG. 4 shows an example computing system 400 for carrying out the methods of the present disclosure, consistent with disclosed embodiments of the present disclosure. Specifically, FIG. 4 shows a block diagram of an embodiment of the computing system 400 according to example embodiments of the present disclosure.

The computing system 400 may be configured to perform any of the operations disclosed herein. The computing system 400 can be implemented as a conventional computer system, an embedded controller, a laptop, a server, a mobile device, a smartphone, a customized machine, any other hardware platform, or any combination or multiplicity thereof. In one embodiment, the computing system 400 is a distributed system configured to function using multiple computing machines interconnected via a data network or bus system.

The computing system 400 includes computing devices (such as a computing device 402). The computing device 402 includes one or more processors (such as a processor 404) and a memory 406. The processor 404 may be any general-purpose processor(s) configured to execute a set of instructions. For example, the processor 404 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 404 may be multiple processing units, a single processing core, multiple processing cores, special-purpose processing cores, co-processors, or any combination thereof. The processor 404 may be communicatively coupled to the memory 406 via an address bus 408, a control bus 410, and a data bus 412. In some embodiments, the processor 404 may correspond to processing circuitry (for example, the processing circuitry 104).

The memory 406 may include non-volatile memories such as a read-only memory (ROM), a programable read-only memory (PROM), an erasable programmable read-only memory (EPROM), a flash memory, or any other device capable of storing program instructions or data with or without applied power. The memory 406 may also include volatile memories, such as a random-access-memory (RAM), a static random-access-memory (SRAM), a dynamic random-access-memory (DRAM), and a synchronous dynamic random-access-memory (SDRAM). The memory 406 may include single or multiple memory modules. While the memory 406 is depicted as part of the computing device 402, a person skilled in the art will recognize that the memory 406 can be separate from the computing device 402.

The memory 406 may store information that can be accessed by the processor 404. For instance, the memory 406 (e.g., one or more non-transitory computer-readable storage mediums, memory devices) may include computer-readable instructions (not shown) that can be executed by the processor 404. The computer-readable instructions may be software written in any suitable programming language or may be implemented in hardware. Additionally, or alternatively, the computer-readable instructions may be executed in logically and/or virtually separate threads on the processor 404. For example, the memory 406 may store instructions (not shown) that, when executed by the processor 404, cause the processor 404 to perform operations such as any of the operations and functions for which the computing system 400 is configured, as described herein. Additionally, or alternatively, the memory 406 may store data (not shown) that can be obtained, received, accessed, written, manipulated, created, and/or stored. The data can include, for instance, the data and/or information described herein in relation to FIGS. 1-3C. In some implementations, the computing device 402 may obtain from and/or store data in one or more memory device(s) that are remote from the computing system 400.

The computing device 402 may further include an input/output (I/O) interface 414 communicatively coupled to the address bus 408, the control bus 410, and the data bus 412. The data bus 412 may include a plurality of tunnels that may support communication in the system environment 100. The I/O interface 414 is configured to couple to one or more external devices (e.g., to receive and send data from/to one or more external devices). Such external devices, along with the various internal devices, may also be known as peripheral devices. The I/O interface 414 may include both electrical and physical connections for operably coupling the various peripheral devices to the computing device 402. The I/O interface 414 may be configured to communicate data, addresses, and control signals between the peripheral devices and the computing device 402. The I/O interface 414 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 414 is configured to implement only one interface or bus technology. Alternatively, the I/O interface 414 is configured to implement multiple interfaces or bus technologies. The I/O interface 414 may include one or more buffers for buffering transmissions between one or more external devices, internal devices, the computing device 402, or the processor 404. The I/O interface 414 may couple the computing device 402 to various input devices, including touch screens, scanners, biometric readers, electronic digitizers, receivers, touchpads, cameras, keyboards, any other pointing devices, or any combinations thereof. The I/O interface 414 may couple the computing device 402 to various output devices, including printers, projectors, tactile feedback devices, automation control, robotic components, actuators, transmitters, signal emitters, lights, and so forth.

The computing system 400 may further include a storage unit 416, a network interface 418, an input controller 420, and an output controller 422. The storage unit 416, the network interface 418, the input controller 420, and the output controller 422 are communicatively coupled to the central control unit (e.g., the memory 406, the address bus 408, the control bus 410, and the data bus 412) via the I/O interface 414. The network interface 418 communicatively couples the computing system 400 to one or more networks such as wide area networks (WAN), local area networks (LAN), intranets, the Internet, wireless access networks, wired networks, mobile networks, telephone networks, optical networks, or combinations thereof. The network interface 418 may facilitate communication with packet-switched networks or circuit-switched networks, which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 416 is a computer-readable medium, preferably a non-transitory computer-readable medium, comprising one or more programs, the one or more programs comprising instructions which, when executed by the processor 404, cause the computing system 400 to perform the method steps of the present disclosure. Alternatively, the storage unit 416 is a transitory computer-readable medium. The storage unit 416 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 416 stores one or more operating systems, application programs, program modules, data, or any other information. The storage unit 416 is part of the computing device 402. Alternatively, the storage unit 416 is part of one or more other computing machines that are in communication with the computing device 402, such as servers, database servers, cloud storage, network-attached storage, and so forth.

The input controller 420 may include suitable logic, circuitry, interfaces, and/or code, executable by the circuitry, that may be configured to control one or more input devices that may be configured to receive camera video streams. The output controller 422 may include suitable logic, circuitry, interfaces, and/or code, executable by the circuitry, that may be configured to control one or more output devices that may be configured to output detected actions, re-identified users, and linked products.

In some embodiments, a computer-readable medium is provided. The computer-readable readable medium includes instructions that, when executed by the processing circuitry 104 or the processor 404 of the computing system 400, may cause the computing system 400 to perform a method for implementing the consensus framework for managing the set of belief spaces. The method includes receiving the first event request associated with at least the first digital artifact of the set of digital artifacts 124 stored in the storage element 106. The set of digital artifacts 124 is associated with the set of belief spaces. The set of belief spaces is stored in the decentralized storage network 114. The first event request is indicative of the proposed change to at least the first digital artifact. The proposed change, when committed, is to be reflected by the first belief space of the set of belief spaces associated with at least the first digital artifact. The method further includes determining, based on the intent of the first event request, the set of acceptance criteria associated with the first event request. The method further includes executing the evaluation process associated with the first event request in accordance with the set of acceptance criteria. The method further includes generating the evaluation response based on the execution of the evaluation process. The evaluation response is indicative of one of: the approval of the first event request or the rejection of the first event request.

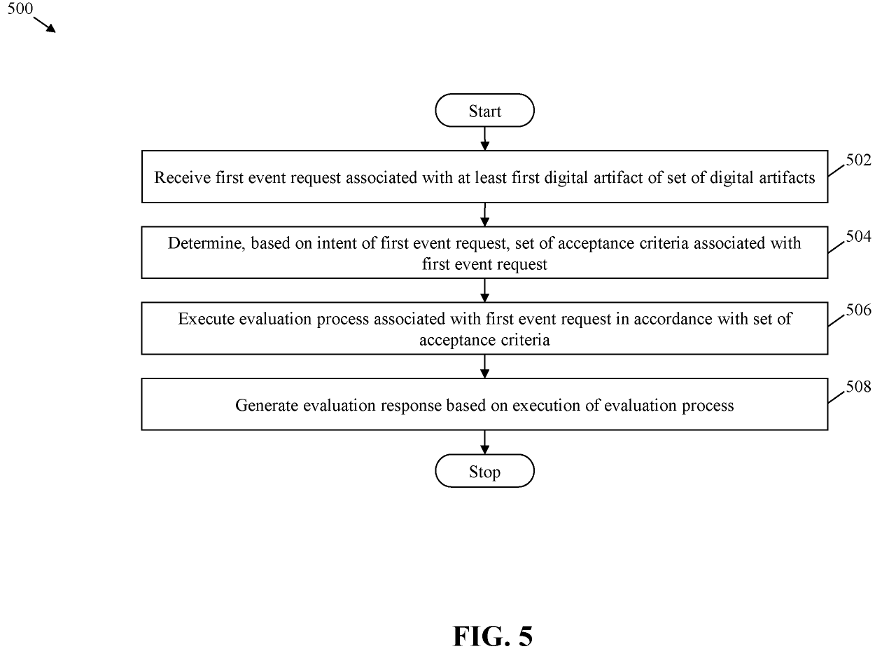

FIG. 5 illustrates a flowchart 500 of a method for consensus-based management of digital artifacts and associated belief spaces, consistent with disclosed embodiments of the present disclosure. Referring to FIG. 5, at 502, the first event request may be received. The processing circuitry 104 may receive the first event request associated with the first digital artifact of the set of digital artifacts 124 from the first PDM device (for example, the user device 120). The first event request may be indicative of the proposed change to the first digital artifact.

At 504, the set of acceptance criteria associated with the first event request may be determined. Based on the intent of the first event request, the processing circuitry 104 may be configured to determine the set of acceptance criteria. The set of acceptance criteria may be indicative of the count of validator agents required for evaluation of the first event, the count of validator agents required for approval of the first event, and evaluation constraints for processing the event request. The method further includes identification of the first subset of validator agents from the set of validator agents 202 based on the set of acceptance criteria. The processing circuitry 104 may be configured to identify the first subset of validator agents from the set of validator agents 202.

At 506, the evaluation process associated with the first event request may be executed. The processing circuitry 104 may execute the evaluation process in accordance with the set of acceptance criteria as described throughout the description.

At 508, based on the execution of the evaluation process, the evaluation response may be generated. The processing circuitry 104 may be configured to generate the evaluation response. The evaluation response may be indicative of the approval of the first event request or the rejection of the first event request.

It should be appreciated that the references to a first element mentioned in the claims may correspond to a second element described in the specification, and vice versa.

The system 102 and method disclosed herein provide significant technical improvements over conventional digital artifacts and belief space management systems. The technical improvements are achieved by implementing a primed consensus framework that implements Byzantine fault-tolerant validation mechanism to solve the technical problem of ensuring the system 102 integrity when human decision-makers propose one or more changes to the digital artifacts. The systems and methods disclosed herein provide significant improvements in security and reliability compared to traditional centralized approval systems that are vulnerable to single points of failure and insider attacks.

The multi-agent architecture of the system 102 delivers significant performance enhancements by enabling parallel evaluation of proposed changes through multiple validator agents, reducing decision-making latency. The integrated creation of the simulation environment and execution of the evaluation process significantly solves the technical problem of safely testing high-risk modifications by creating isolated execution spaces that replicate production conditions without affecting operational systems, eliminating the costly downtime and potential data corruption associated with direct production testing methods.

The storage of the set of belief spaces by way of a blockchain-based decentralized storage network 114 significantly resolves the technical problem of accountability and traceability in high-stakes decision-making processes, providing verifiable records that enable post-incident analysis and regulatory compliance. The time-locked transaction mechanism with challenge periods, implemented by way of the wait time before the execution of the first set of operations, offers practical benefits for enterprise environments by allowing stakeholder review of the proposed change before permanent implementation, reducing the risk of irreversible errors.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process; however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for the implementation of a blockchain-based consensus framework for management of belief spaces. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system comprising:
a storage element configured to store a set of digital artifacts, wherein the set of digital artifacts is associated with a set of belief spaces, and wherein the set of belief spaces is stored in a decentralized storage network associated with the system; and
processing circuitry coupled to the storage element, wherein the processing circuitry is configured to:
receive a first event request associated with at least a first digital artifact of the set of digital artifacts, wherein the first event request is indicative of a proposed change to at least the first digital artifact, and wherein the proposed change, when committed, is to be reflected by a first belief space of the set of belief spaces, associated with at least the first digital artifact;
determine, based on an intent of the first event request, a set of acceptance criteria associated with the first event request;
execute an evaluation process associated with the first event request in accordance with the set of acceptance criteria; and
generate an evaluation response based on the execution of the evaluation process, wherein the evaluation response is indicative of one of: an approval of the first event request or a rejection of the first event request.

2. The system of claim 1, wherein, based on the evaluation response being indicative of the approval of the first event request, the processing circuitry is further configured to:
execute a first set of operations associated with the first event request; and
commit, based on the execution of the first set of operations, the proposed change to at least the first digital artifact.

3. The system of claim 2, wherein the processing circuitry is further configured to:
access the first belief space in the decentralized storage network; and
update the first belief space based on the commitment of the proposed change to at least the first digital artifact.

4. The system of claim 3,
wherein the first belief space corresponds to a set of belief types associated with a set of belief states,
wherein a first belief type, of the set of belief types, is indicative of a first attribute associated with at least the first digital artifact,
wherein a first belief state, of the set of belief states, is associated with the first belief type,
wherein the first belief state is indicative of a current state of the first attribute, and
wherein, to update the first belief space, the processing circuitry is further configured to:
identify, based on a first context of the first set of operations, a subset of belief types of the set of belief types, wherein the subset of belief types corresponds to one or more attributes, associated with at least the first digital artifact, with a change in corresponding current states based on the commitment of the proposed change to at least the first digital artifact; and
update a subset of belief states, of the set of belief states, associated with the subset of belief types based on a set of outputs of the first set of operations.

5. The system of claim 1,
wherein the storage element is further configured to store a set of logic constraints, and
wherein the processing circuitry is further configured to:
identify, based on the intent of the first event request, a first subset of logic constraints of the set of logic constraints associated with the first event request, wherein the set of acceptance criteria associated with the first event request is determined further based on the first subset of logic constraints.

6. The system of claim 1,
wherein the storage element is further configured to store a set of logic constraints, and
wherein the processing circuitry is further configured to:
identify, based on the intent of the first event request, a second subset of logic constraints of the set of logic constraints associated with the first event request, wherein the evaluation process associated with the first event request is executed further based on the second subset of logic constraints.

7. The system of claim 1, wherein the storage element is further configured to store at least one of: a set of validator agents, a simulator agent, or an orchestrator agent.

8. The system of claim 7, wherein the set of acceptance criteria is indicative of at least one of: a count of validator agents required for an evaluation of the first event request, a count of validator agents required for the approval of the first event request, or one or more evaluation constraints associated with at least one of: the evaluation of the first event request or an execution of the first event request.

9. The system of claim 8, wherein for the execution of the evaluation process, the processing circuitry is further configured to:
select, based on utilization of the orchestrator agent, a subset of validator agents from the set of validator agents based on the count of validator agents required for the evaluation of the first event request; and
communicate, via the orchestrator agent, at least one of: the first event request or the one or more evaluation constraints associated with at least one of: the evaluation of the first event request or the execution of the first event request to the simulator agent, wherein the simulator agent is configured to:
create a simulation environment associated with at least the first digital artifact;
execute a first set of operations associated with the first event request for at least the first digital artifact in the simulation environment; and
communicate a set of outputs associated with the first set of operations to the orchestrator agent.

10. The system of claim 9,
wherein the processing circuitry is further configured to communicate, based on the utilization of the orchestrator agent, the set of outputs to the subset of validator agents, and
wherein each validator agent of the subset of validator agents is configured to:
evaluate the first event request based on at least one of: the set of outputs or the one or more evaluation constraints;
generate an intermediate evaluation response based on the evaluation of the first event request; and
communicate the intermediate evaluation response to the orchestrator agent.

11. The system of claim 10, wherein for the evaluation of the first event request, the subset of validator agents, collectively or individually, is configured to:
monitor the execution of the first set of operations in the simulation environment;
determine a set of observations associated with the execution of the first set of operations, wherein the first event request is evaluated further based on the set of observations; and
identify a set of collateral operational conditions pertaining to a subset of digital artifacts of the set of digital artifacts, wherein each digital artifact of the subset of digital artifacts is associated with at least the first digital artifact, wherein the execution of the first set of operations causes the set of collateral operational conditions, and wherein the intermediate evaluation response is generated further based on the set of collateral operational conditions.

12. The system of claim 11, wherein the association of each digital artifact of the subset of digital artifacts with at least the first digital artifact is one of: a syntactic association or a semantic association.

13. The system of claim 10,
wherein the processing circuitry is further configured to generate the evaluation response based on the utilization of the orchestrator agent, and
wherein the orchestrator agent is configured to:
receive the intermediate evaluation response from each validator agent of the subset of validator agents, wherein the intermediate evaluation response is indicative of one of: the approval of the first event request or the rejection of the first event request;
determine that one of: a count of intermediate evaluation responses indicative of the approval of the first event request exceeds the count of validator agents required for the approval of the first event request, or the count of intermediate evaluation responses is less than the count of validator agents required for the approval of the first event request;
generate the evaluation response that is indicative of the approval of the first event request based on the count of intermediate evaluation responses exceeding the count of validator agents required for the approval of the first event request; and
generate the evaluation response that is indicative of the rejection of the first event request based on the count of intermediate evaluation responses being less than the count of validator agents required for the approval of the first event request.

14. The system of claim 13, wherein the orchestrator agent is further configured to generate a set of feedback based on a second context associated with the evaluation response, and wherein the set of feedback is indicative of a set of reasonings pertaining to the evaluation response being indicative of one of: the approval of the first event request or the rejection of the first event request.

15. The system of claim 1, wherein, based on the evaluation response being indicative of the approval of the first event request, the processing circuitry is further configured to:
schedule an execution of a first set of operations associated with the first event request based on an expiration of a predefined time interval;
receive an override request for the first event request prior to the expiration of the predefined time interval;
evaluate the override request based on a third context thereof; and
update the scheduled execution of the first set of operations based on the evaluation of the override request.

16. The system of claim 1, wherein the processing circuitry is further configured to:
receive a second event request associated with at least one of: at least the first digital artifact or a second digital artifact of the set of digital artifacts;
determine that a first set of operations associated with the first event request conflicts with a second set of operations associated with the second event request;
generate, for each of the first event request and the second event request, a corresponding priority score, wherein a first priority score and a second priority score associated with the first event request and the second event request is generated based on a first source of the first event request and a second source of the second event request, respectively; and
schedule execution of at least one of the first set of operations or the second set of operations based on the first and second priority scores.

17. A method, comprising:
receiving, by processing circuitry, a first event request associated with at least a first digital artifact of a set of digital artifacts stored in a storage element,
wherein the set of digital artifacts is associated with a set of belief spaces,
wherein the set of belief spaces is stored in a decentralized storage network,
wherein the first event request is indicative of a proposed change to at least the first digital artifact, and
wherein the proposed change, when committed, is to be reflected by a first belief space of the set of belief spaces, associated with at least the first digital artifact;
determining, by the processing circuitry, based on an intent of the first event request, a set of acceptance criteria associated with the first event request;
executing, by the processing circuitry, an evaluation process associated with the first event request in accordance with the set of acceptance criteria; and
generating, by the processing circuitry, an evaluation response based on the execution of the evaluation process, wherein the evaluation response is indicative of one of: an approval of the first event request or a rejection of the first event request.

18. The method of claim 17, further comprising:
executing, by the processing circuitry, based on the evaluation response being indicative of the approval of the first event request, a first set of operations associated with the first event request; and
committing, by the processing circuitry, based on the execution of the first set of operations, the proposed change to at least the first digital artifact.

19. The method of claim 18, further comprising:
accessing, by the processing circuitry, the first belief space in the decentralized storage network; and
updating, by the processing circuitry, the first belief space based on the commitment of the proposed change to at least the first digital artifact.

20. A non-transitory computer-readable medium comprising instructions that, when executed by processing circuitry of a computing system, cause the computing system to perform a method for implementing a consensus framework for managing a set of belief spaces, the method comprising:
receiving a first event request associated with at least a first digital artifact of a set of digital artifacts stored in a storage element,
wherein the set of digital artifacts is associated with the set of belief spaces,
wherein the set of belief spaces is stored in a decentralized storage network,
wherein the first event request is indicative of a proposed change to at least the first digital artifact, and
wherein the proposed change, when committed, is to be reflected by a first belief space of the set of belief spaces, associated with at least the first digital artifact;
determining, based on an intent of the first event request, a set of acceptance criteria associated with the first event request;
executing an evaluation process associated with the first event request in accordance with the set of acceptance criteria; and
generating an evaluation response based on the execution of the evaluation process, wherein the evaluation response is indicative of one of: an approval of the first event request or a rejection of the first event request.
